(19) United States
(12) Patent Application Publication
(10) Pub. No.: US 2026/0330194 A1
(43) Pub. Date: Oct. 22, 2026

(54) VISUAL REASONING AND MULTIMODAL CHAIN-OF-THOUGHT BACK-END

(71) Applicant: OpenAI OpCo, LLC, San Francisco, CA (US)

(72) Inventors: Tony Casparro, San Luis Obispo, CA (US); Alexander Christakis, San Francisco, CA (US); Sean Fitzgerald, Palo Alto, CA (US); Adam Fry, Corte Madera, CA (US); Robert Joseph Marsan, San Rafael, CA (US); Rennie Song, San Francisco, CA (US); Ignacio Soto Bustos, Kensington, CA (US); Zachary Sultan, Albany, CA (US)

(73) Assignee: OpenAI OpCo, LLC., San Francisco, CA (US)

(21) Appl. No.: 19/389,708

(22) Filed: Nov. 14, 2025

Related U.S. Application Data
(63) Continuation of application No. 19/364,606, filed on Oct. 21, 2025.
(60) Provisional application No. 63/789,762, filed on Apr. 16, 2025.

(51) Int. Cl. G06N 3/0475

(52) U.S. Cl. CPC G06N 3/0475

(57) ABSTRACT

A system is configured to present intermediate reasoning steps of a multimodal reasoning model. The system includes instructions that cause one or more processors to be configured to present a user interface to show render reasoning outputs. The one or more processors are further configured to: receive, from a server, a plurality of reasoning messages generated during execution of the multimodal reasoning model, each reasoning message including metadata identifying a message type; determine, based on the message type, a presentation format for each reasoning message, the presentation format including at least one of a visual style, an animation sequence, or a display duration; render, via the user interface, the plurality of reasoning messages in a reasoning timeline according to their respective presentation formats; and update the reasoning timeline in real time as additional reasoning messages are generated.

### PRIORITY CLAIM

This application is a continuation of U.S. patent application Ser. No. 19/364,606 filed on Oct. 21, 2025, which claims priority to U.S. Provisional Patent Application No. 63/789,762 filed on Apr. 16, 2025, the contents of which are incorporated herein by reference, for all purposes, as if fully set forth herein.

### BACKGROUND

Recent advances in multimodal reasoning systems have enabled artificial intelligence models to process and integrate diverse input types—such as text, images, code, and structured data—within a unified reasoning framework. State-of-the-art models now perform “chain-of-thought” reasoning across multiple modalities, combining textual analysis, visual understanding, and dynamic tool usage to deliver context-aware results. These systems increasingly leverage real-time interactions with auxiliary tools, including web search, code execution engines, and image manipulation utilities, to solve complex, multi-step problems. As the complexity of multimodal reasoning grows, coordinating outputs from concurrent processes has become critical for ensuring consistency, accuracy, and reliability in user-facing applications.

Despite these advancements, integrating multimodal reasoning with tool-assisted workflows presents significant technical challenges. Models often generate diverse intermediate outputs—including search results, image analyses, and internal reasoning artifacts—that are difficult to organize and present to end users. Without effective backend management, concurrent tool calls and asynchronous reasoning processes may produce mismatched outputs, incomplete responses, or degraded performance. As these systems become increasingly agentic and capable of performing multi-step reasoning tasks with minimal user input, there is a growing need for robust backend architectures that can manage, structure, and synchronize heterogeneous streams of information while maintaining low latency and a coherent presentation layer.

Delivering a seamless and responsive user experience in these environments requires balancing competing technical demands. On one hand, users expect near-real-time results even when models execute multiple parallel tool calls or process extended chains of thought across several data modalities. On the other hand, backend systems must ensure that intermediate reasoning outputs, structured summaries, and search-based responses remain consistent, contextually accurate, and properly ordered for presentation. These requirements are further complicated by variable latency across tools, dynamic resource constraints, and the need to safeguard sensitive intermediate reasoning artifacts. As artificial intelligence (AI) systems evolve toward more dynamic, multi-agent workflows, backend architectures capable of intelligently coordinating asynchronous reasoning, multimodal integration, and client-ready summaries are becoming increasingly essential.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. The drawings and block diagrams herein illustrate example implementations for explanatory purposes only and are not intended to represent literal hardware or software architectures. The described components and sequences may be combined, rearranged, or implemented in different forms without departing from the scope of the claims. Other features, aspects, and advantages will become apparent from the description, the drawings, and the claims.

FIG. 1 is an example system including a generative response engine and user device with a user interface, in accordance with some aspects of the present technology.

FIG. 2A illustrates an example chain-of-thought reasoning model, in accordance with some aspects of the present technology.

FIG. 2B illustrates an example user interface presenting data from a chain-of-thought reasoning model, in accordance with some aspects of the present technology.

FIG. 3 illustrates an example back-end orchestration and summarization engine and a frontend, in accordance with some aspects of the present technology.

FIG. 4 illustrates an example method in accordance with some aspects of the present technology.

FIG. 5 illustrates an example method in accordance with some aspects of the present technology.

FIG. 6 illustrates another example method in accordance with some aspects of the present technology.

FIG. 7 shows an example of a system for implementing some aspects of the present technology.

### DETAILED DESCRIPTION

Various aspects of the disclosure are discussed in detail below. While specific implementations are discussed, it should be understood that this is done for illustration purposes only. A person skilled in the relevant art will recognize that other components and configurations may be used without departing from the spirit and scope of the disclosure. Existing large language model (LLM) systems and AI models typically do not fully process images that may be attached to a user interface or user input field along with a prompt. Existing systems fail to consider images as reasoning elements in a chain-of-thought and struggle or fail to manipulate images during the reasoning process.

To address the challenges described above, this disclosure introduces systems and methods for managing multimodal chain-of-thought (CoT) reasoning in environments where inputs and outputs span multiple data types, including one or more of text, images, code, and structured search results. In one aspect, the approach receives multimodal inputs and processes them through a CoT reasoning model that generates both reasoning tokens and one or more tool calls. Tool-call responses and reasoning outputs are intelligently queued, buffered, and selectively released to a summarization model, which generates structured step summaries representing each stage of a multi-step reasoning process. The summaries can then be returned to an application programming interface (API) or client interface in a form optimized for parsing and rendering.

In certain aspects, the summarization model performs asynchronous summarization of reasoning tokens while enabling synchronous release of tool-call responses, improving perceived responsiveness without sacrificing completeness. Other aspects allow the system to dynamically adjust the size of reasoning-token chunks based on factors such as latency thresholds, token-generation rates, or available summarization resources, enabling efficient adaptation to varying workloads and user contexts. Additionally, the system can normalize multimodal outputs into a standardized metadata format with visibility flags that specify whether corresponding tokens, tool-call responses, or intermediate reasoning artifacts should be displayed or protected, ensuring consistent and secure client-side rendering.

For example, in a multimodal reasoning session where a model analyzes an uploaded image, retrieves supporting information via search, and executes Python code to process results, the disclosed techniques ensure that outputs are delivered in the correct order, summarized appropriately, and presented cohesively to the user without exposing sensitive intermediate reasoning. By coordinating these asynchronous processes, dynamically optimizing summarization, and providing structured, normalized outputs, the disclosed systems enable more reliable, lower-latency, and user-friendly multimodal reasoning experiences.

In some aspects, an example backend orchestration engine for orchestrating multimodal chain-of-thought reasoning can perform structured summarization, and asynchronous output management. The backend orchestration engine receives a sequence of messages from a reasoning model, which may include text outputs, tool-call results, and structured multimodal data such as images, search results, or code execution outputs. For textual reasoning messages, the backend orchestration engine generates user-facing summaries in a structured format, while non-text outputs undergo modality-specific transformations.

Processed outputs are inserted into an ordered message queue and delivered to client applications in the correct sequence, even when summarization tasks complete asynchronously. The backend orchestration engine supports chunking and buffering of reasoning tokens, dynamic adjustment of summarization size based on latency and resource constraints, and metadata tagging for consistent rendering. Sensitive information is sanitized, multimodal outputs are normalized, and different communication channels are used to distinguish between visible summaries and hidden intermediate reasoning, improving performance, security, and user experience.

Additional aspects include a system having one or more processor and memory storing instructions which, when executed, cause the system to perform the above method. In another aspect, a non-transitory computer-readable medium stores instructions that, when executed by one or more processor, cause performance of the method described herein.

This disclosure also describes concepts relating to presenting intermediate reasoning steps of a multimodal reasoning model in real time, enabling users to observe the evolution of reasoning, visual outputs, and supporting artifacts as the system processes a prompt. The method (implemented by a system or computer-readable medium) can integrate textual, visual, and external data sources into a unified, dynamic display that highlights the relationships between individual reasoning steps, intermediate outputs, and final results along a reasoning timeline. For example, the method can include presenting intermediate reasoning steps generated during execution of a multimodal reasoning model. The method includes receiving a plurality of reasoning messages from a server, where each reasoning message corresponds to a different stage of the reasoning process and may include text outputs, processed images, search results, or code execution results. Based on the type of each reasoning message, the system determines a presentation format that specifies visual styles, animation sequences, and display durations optimized for the content.

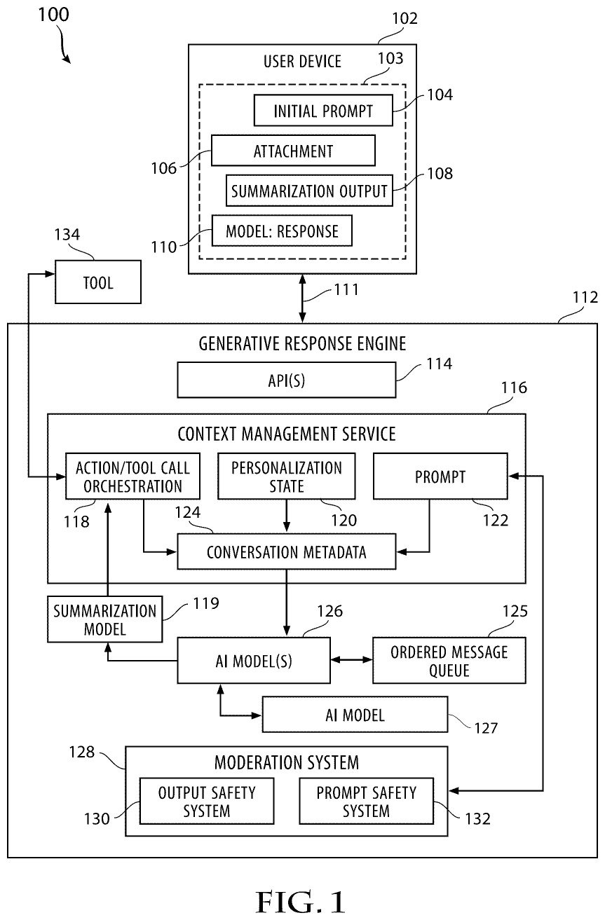

The method further includes rendering the reasoning messages along a reasoning timeline to visually represent the model's evolving thought process, while updating the timeline in real time as new reasoning messages are generated. By dynamically presenting intermediate outputs in a cohesive, multimodal display, the method provides users with a transparent, intuitive view of the reasoning process and its associated artifacts. The intermediate outputs described above can also be summarization outputs, which are introduced with respect to FIG. 1.

Additional features and advantages of the disclosure will be set forth in the description which follows, and in part will be evident from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

This disclosure provides systems and methods for coordinating multimodal chain-of-thought reasoning by intelligently queuing, buffering, and summarizing reasoning outputs and tool-call responses, thereby enabling low-latency, structured, and contextually accurate results across diverse data modalities.

FIG. 1 illustrates a block diagram showing a generative response engine framework 100 including a user device 102, a user interface 103, a prompt 104, an attachment 106, such as an image, text, audio, video, or a multimodal attachment, a summarization output 108, and a response 110. Communications 111 between the user device 102 and a generative response engine 112 are exchanged to enable the user to provide the input and receive the response. The generative response engine 112 can include many different components, including a summarization model 119, a CoT reasoning model 127, and an ordered message queue 125.

Note that the input that is received and processed herein is typically described as coming from a user, but in some aspects, the input (images, audio, text, multiple inputs of different types, etc.) could also be received as a response from a tool call to tool 134 or from a separate application or service.

The prompt 104 is typically a natural language prompt, but other prompts might include an attachment 106, such as an image, text, a video, a file, or multimodal input types. While the primary example is described herein with the attachment 106 being an image, the process can represent or be applied to any kind of non-textual or even, in some cases, additional textual input. For example, the attachment 106 may be a video or an audio file. The audio file may be manipulated, sped up, slowed down, played backwards, or processed in ways similar to how an image might be cropped, zoomed-in, tilted, reversed, and so forth when processed.

The prompt 104 can be user-generated or generated by a computing device, such as user device 102 or another computing device. The prompt 104 is provided to the generative response engine 112.

Generative response engines are a class of artificial intelligence tools that can generate responses to prompts. Many generative response engines provide a conversational user interface powered by a chatbot or any kind of user interface to generative response engine 112. Generative response engine 112 may be a small single-shot model or it may be a larger deep-reasoning model. The principles disclosed herein are independent of a particular type of AI model or configuration of generative response engine 112.

The user interface 103 provides an intuitive format to provide prompts or instructions to generative response engine 112. The conversational user interface powered by a chatbot can be so effective that users feel like they are interacting with someone. The user interface 103 can be configured to display interim reasoning outputs as the summarization output 108 generated by the generative response engine 112.

The prompt 104 may be provided by a user of the user device 102 or may be generated by a computing system or application. Thus, the user device 102 can represent a device of a user or a computing device that may be running an application that generates the prompt 104. The prompt 104, the summarization output 108, the response 110, and other data can be presented in a user interface 103.

The generative response engine 112 or a model from AI model(s) 126 can be a reasoning model selected based on a complexity determination for the prompt 104. For simpler prompts, a single-shot or simple model may be selected. A fast, non-reasoning model could be used for simpler prompts. For more complex prompts, a deep reasoning or more sophisticated model of the AI model(s) 126 may be chosen.

FIG. 1 further illustrates various components of the generative response engine 112 during inference operations in accordance with some aspects of the present technology. Although the example system depicts particular system components and an arrangement of such components, this depiction is to facilitate a discussion of the present technology and should not be considered limiting unless specified in the appended claims. For example, some components illustrated as separate can be combined with other components, and some can be divided into separate components. This disclosure focuses on the concepts of visual reasoning and a multimodal chain-of-thought backend processing capability.

When the generative response engine 112 receives the prompt 104, the processing pipeline begins with tokenization, whereby the input text is converted into a sequence of discrete symbols, or tokens. This is typically accomplished using a subword segmentation algorithm such as byte pair encoding (BPE) or a similar statistical method that maps textual input to numerical token IDs. These token IDs are then passed into an embedding layer, transforming each token into a high-dimensional vector representation that captures both semantic and syntactic properties. Positional encodings can be added to each embedded token to preserve the order of the input sequence, enabling the model to distinguish between tokens based on their relative or absolute position within prompt 104.

The embedded token sequence is then input into a component of the generative response engine 112, such as a deep neural network, most commonly a transformer-based architecture, which processes the sequence through multiple layers of self-attention and feedforward operations.

At each layer, the generative response engine 112 computes attention scores that allow it to dynamically weight the influence of each token in the sequence relative to others, effectively modeling contextual dependencies across the entire input. As the data propagates through the layers, the generative response engine 112 forms a progressively abstract representation of the prompt 104, capturing relationships between terms, inferential structures, and latent semantic intent. These processes can be part of the active inference trajectory associated with processing the prompt 104.

The generative response engine 112 may not execute a symbolic or rule-based inference engine. Instead, its reasoning capabilities can be emergent from the distributed representations and statistical correlations learned during training on large document corpora. When the prompt 104 presents a task that requires reasoning —such as multi-step arithmetic, analogical thinking, or query decomposition —the generative response engine 112 may internally simulate or initiate a chain of reasoning by activating sequential patterns of intermediate representation. These latent states are shaped by previously observed sequences in the training data and allow the generative response engine 112 or model to decompose and respond to complex queries without explicit task-specific programming.

Following the encoding and transformation of the input, the generative response engine 112 enters a decoding phase, in which it autoregressively generates output tokens one at a time. At each step, the engine computes a probability distribution over its vocabulary conditioned on the input and previously generated tokens, and selects the next token using a predefined decoding strategy (e.g., greedy decoding, top-k sampling, or nucleus sampling). This process continues iteratively until an end-of-sequence token is emitted or a token limit is reached. The resulting token sequence is then detokenized, converting the output back into human-readable text. The response 110 is then provided to the user interface 103.

The generative response engine 112 typically operates as a self-contained system: all semantic understanding, contextual inference, and content generation occur within the confines of the model's learned parameters. The generative response engine 112 typically does not access external databases, execute queries, or invoke symbolic reasoning modules during inference. However, it can call external tools such as tool 134 as part of processing user input. The output of the generative response engine 112 is typically derived entirely from the internal transformation and extrapolation of the prompt 104, and any associated additional data, guided by its pretrained neural architecture and parameter set. This disclosure introduces a new approach to providing a visual reasoning aspect and a multimodal chain-of-thought backend with a number of different related features.

In generative response engine 112, the chain of reasoning arises through a deep neural architecture-typically a transformer-based network-including multiple stacked layers of self-attention and feedforward computations. Upon receiving a natural language prompt, the engine performs tokenization to segment the input into discrete units, which are then mapped to numerical token identifiers. These tokens are embedded as high-dimensional vectors that capture semantic and syntactic features, and are further enhanced by positional encodings to preserve sequence order. As the embedded input propagates through each layer of the transformer, self-attention mechanisms compute dynamic weightings across the full sequence, enabling the engine to contextualize each token relative to all others.

This layer-wise computation forms a progressively more abstract representation of the input, where attention heads and dense transformations interact to model complex relationships. The resulting activations at each layer form a latent trajectory through vector space that reflects an evolving understanding of the prompt. Each step in this trajectory corresponds to an intermediate state that contributes to the final output or the response 110. Importantly, the architecture supports distributed reasoning: no single node or layer performs an entire inferential step, but instead, inference emerges from patterns distributed across the network.

Functionally, the chain of reasoning simulates multi-step inferential processing by encoding intermediate sub-tasks within the latent representations formed at various layers. When a task involves logical decomposition, contextual inference, or arithmetic resolution, the model internally progresses through conceptual stages such as entity recognition, disambiguation of relations, hypothesis formation, and output synthesis—all without explicitly storing symbolic variables or invoking deterministic rules.

For example, if the prompt 104 is: “If Alice has twice as many apples as Bob, and together they have 18 apples, how many does Alice have?”, the generative response engine 112 may implicitly recognize the relationship, translate it into an algebraic structure, compute a result, and then express that result in natural language. These stages are encoded entirely within the learned weights and activation patterns and are conditioned dynamically on both the content and structure of the prompt 104. The model's generation process is autoregressive: after internal encoding, it emits one output token at a time by computing a probability distribution over the vocabulary conditioned on the accumulated history. This decoding continues until a stopping condition is met. The reasoning chain thus guides the generation at each step, refining the probability landscape over output tokens based on a learned internal representation of the task.

There are a number of interpretive characteristics of the chain of reasoning. The chain of reasoning in generative response engine 112 can be characterized by its distributed, statistical, and context-sensitive nature. It is distributed in that no discrete symbolic step exists. Rather, the reasoning is encoded across activation states that span multiple tokens, layers, and attention paths. It is statistical because it emerges from probabilistic patterns learned from large-scale training data, rather than from any explicit logic, rules, or ontology. It is context-sensitive because the same model can apply different internal reasoning patterns depending on the phrasing, complexity, and intent of the prompt. Unlike expert systems or logic engines, generative response engine 112 generally does not invoke external memory, symbolic databases, or step-by-step solvers during inference, although it may invoke external tools such as tool 134 to assist in its reasoning. All reasoning occurs through internal transformation of embedded vectors within the model's fixed parameter space. As such, the chain of reasoning represents a learned and continuous approximation of logical and inferential behavior, simulated entirely within the framework of neural computation.

The prompt 104 is generally in natural language but could be in code, including binary. Some examples of AI model(s) 126 can include language models that generate language, such as CHATGPT, or other models, such as DALL-E or IMAGEGEN, which generate images, and SORA, which generates videos. CHATGPT, DALL-E, IMAGEGEN, and SORA are all provided by OPENAI, but the AI model(s) 126 are not limited to AI provided by OPENAI. AI model(s) 126 can also be any type of generative AI and can include AI developed using various architectures such as diffusion models and transformers (e.g., autoregressive transformer architecture) and combinations of models. Some AI models are multimodal models that can receive and output data in text, image, audio, etc.

In some instances, a language model, such as CHATGPT, can receive prompt 104 to output images, video, code, applications, etc., which it can provide by interfacing with one or more other models, as will be addressed further herein.

AI model(s) 126 may be part of the generative response engine 112, where generative response engine 112 may include one or more components for supporting interaction with AI model(s) 126. Users can also interact with generative response engine 112 through API(s) 114.

While some components are shown as part of generative response engine 112 and some are outside of generative response engine 112, this is for illustration purposes only. Some components, such as tool 134, might be part of generative response engine 112, and some components, such as moderation system 128, might be outside of generative response engine 112. As used herein, generative response engine 112 encompasses deterministic services that are first-party services that prepare prompts to be sent to AI model(s) 126, that are primitive level services that AI model(s) 126 can utilize to generate a response to prompt 104. Services that are outside of generative response engine 112 are logically separate.

The use of the tool 134 can represent an active tool integration, meaning that active tools (e.g., an Internet browser, a file search tool, a python tool, GitHub, Slack, Drive, a calendar application, a social media application, an image processing tool, an audio processing tool, and so forth) that are part of an interaction with the AI model(s) 126.

Some components of generative response engine 112 might be executed by a computing processing unit (CPU), and some components might be executed by graphical processing units (GPU) (e.g., AI model(s) 126).

Generative response engine 112 can provide one or more application programming interfaces (API(s)) such as API(s) 114. APIs enable developers to integrate the AI model's capabilities into external applications and services. API(s) 114 provide programmatic access to generative response engine 112, allowing for customized interactions and functionalities. API(s) 114 can refer to points of access to AI model(s) 126. In some examples, API(s) 114 endpoints are located at a context management service 116, introduced below.

There can also be APIs that direct AI model(s) 126 and/or generative response engine 112 to interface with other applications or other generative AI engines. In such cases, the specific application or AI engine might be specified, or AI model(s) 126 might be allowed to choose another application of generative response engine 112 to use in response to prompt 104 as well as any attachments.

Generative response engine 112 may also include a context management service 116. The function of context management service 116 is to manage and organize the flow of data among key subsystems, enabling AI model(s) 126 to generate responses that are contextually relevant, accurate, and enriched with additional information as required. The context management service 116 may obtain data from the prompt 104 and/or the attachment 106, to provide context for a conversation.

Action service 118 facilitates auxiliary tasks that extend beyond basic text generation. In some aspects, action service 118 can cause actions to be performed that correspond to API(s) 114. In some aspects, actions from action service 118 can be agentic actions that AI model(s) 126 decide to take to carry out a user's intent as described in the prompt 104 and/or the attachment 106. For example, an action can be to call tool 134 or even other AI model(s) 126. Tool 134 can include internet browsers, editors such as code editors, other AI tools, etc. While tools such as tool 134 are shown outside of generative response engine 112, some tools might be part of generative response engine 112, and some tools might be external. Action service 118 may also relate to processing according to the prompt 104 or data, a text-based attachment, the attachment 106 or instructions.

Context management service 116 can include a personalization state 120. In some aspects, AI model(s) 126 can provide instructions related to personalization state 120 to record facts in a personalization notepad. Personalization state 120 can store information received directly from a user account or inferred from the prompt 104 and/or the attachment 106, and can be used to provide context to the AI model(s) 126 for more robust processing. Personalization state 120 can also include summaries of past conversation threads between the user and the generative response engine 112, and/or a searchable index of past conversation threads. Data stored with personalization state 120 can also relate to active tool integration. In this way, the personalization state 120 and the generative response engine 112 and/or the AI model(s) 126 learn specific facts about a user and recall past interactions. The past interactions can be used to guide future responses by the generative response engine 112 and/or AI model(s) 126.

Personalization state 120 can facilitate continuity and personalization in conversations. It allows the system to maintain user-specific context, preferences, or details that may inform future interactions. Personalization state 120 can include a memory file of persisted data from previous interactions or sessions that provide background information to maintain continuity. Personalization state 120 can include or utilize data from the prompt 104 and/or attachments associated with prompt 104 to provide context or relative information to personalize a conversation with the user. In some aspects, information can be recorded to personalization state 120 at the instruction of AI model(s) 126 when AI model(s) 126 identify a fact or data that it determines should be saved in memory because the fact and/or data might be useful in later conversations or sessions. In some aspects, personalization state 120 can also include synthesized concepts extracted from past conversation threads. Personalization state 120 can also encompass the ability of AI model(s) 126 to search through past interactions to find relevant information to a current conversation thread.

In some aspects, the tool 134 might represent one or more tools integrated with or associated with the prompt 104 or other tasks. Where the input to generative response engine 112 is multimodal or containing multiple different text input or attachments (i.e., attachment 106), the tool 134 can be called to process data. When an application or external tool, such as tool 134, is being used or is planned to be used, data about the tool 134 can provide further context or information that can be used to improve the prompt 104. The prompt 104 can include context-dependent instructions dynamically selected based on available external tool integrations, including one or more of: GitHub, Slack, Drive, a file storage system, a code repository, a messaging platform, a social media platform, a calendar integration, a website, an application, a high-performance computing system, a cloud computing environment, a financial system, a gaming system, and so forth. The context-dependent instructions can relate to tool 134, its operation, actions to be taken, data to be transmitted or received, content that can be generated using tool 134, and so forth.

Communications 111 between the generative response engine 112 and the user device 102 can include the prompt 104, an attachment 106, a summarization output 108 and a response 110. For example, the summarization output 108 may report or ask the user to confirm that prompt 104, which references “Moscow”, is about Moscow, Idaho, not Moscow, Russia. In general, the generative response engine 112 will provide the response 110 back to the user device 102 after processing one or more of the prompt 104, attachment 106 and any other additional responses that can further interrupt the chain of reasoning.

In some aspects, the system includes a summarization model 119 configured to process outputs generated by a CoT reasoning model 127 which in some aspects could be a chain-of-thought (CoT) reasoning model or other type of model in environments involving multimodal inputs and outputs. The summarization model 119 can operate as an intermediary processing layer between the CoT reasoning model 127 and client-facing components, transforming unstructured reasoning tokens, tool-call responses, and multimodal artifacts into structured, context-ready summaries suitable for display such as via the summarization output 108 or integration into downstream workflows. By managing asynchronous reasoning streams, normalizing diverse outputs, and preserving contextual continuity, summarization model 119 ensures that users receive low-latency, coherent, and sanitized results without exposing sensitive intermediate reasoning processes.

Summarization model 119 performs asynchronous summarization of reasoning tokens produced by the CoT reasoning model 127 or other AI model(s) 126. In some aspects, the CoT reasoning model 127 may produce multiple streams of outputs, including reasoning tokens and tool-call responses. Summarization model 119 is configured to incrementally process reasoning tokens as they are generated, without requiring the CoT reasoning model 127 to complete its entire reasoning sequence. At the same time, tool-call responses from the tool 134 (as an example of any number of possible tools that can be called), such as search results, code execution outputs, or image manipulations, may be released synchronously for immediate use by downstream components or a client-facing interface. This architecture enables the system to provide partial results as a summarization output 108 in real time while continuing to process remaining reasoning content in the background.

This disclosure includes the concept of dynamic chunking and performance optimization. In some aspects, summarization model 119 dynamically adjusts the size of reasoning-token chunks sent for summarization. Chunk sizes may be determined based on one or more operational parameters, such as (i) a latency threshold, (ii) a token-generation rate of the CoT reasoning model 127, or (iii) the availability of summarization resources. For example, summarization model 119 may initially summarize one hundred and fifty tokens, then increase the chunk size to three hundred or more tokens as additional outputs are generated and processing conditions allow. This adaptive approach optimizes system responsiveness and computational efficiency, enabling the summarization process to scale gracefully across diverse workloads and user contexts.

Summarization model 119 can be configured to generate structured step summaries based on reasoning tokens and tool-call responses provided by the CoT reasoning model 127. Each step summary can be presented on the user interface 103 as summarization output 108. A respective step summary may include one or more of: (i) a step title indicative of a corresponding reasoning stage and (ii) a step description summarizing the key insights associated with that stage. In some aspects, these structured step summaries are generated in formats designed for efficient client-side parsing and rendering. The structured nature of the outputs allows them to be presented as collapsible or progressive reasoning cards in a user interface while preserving the sequence and context of multi-step reasoning workflows.

The summarization model 119 can perform normalization and metadata generation. In some aspects, summarization model 119 normalizes multimodal outputs received from the CoT reasoning model 127 and one or more tool calls to tool 134. Because reasoning processes may involve text, images, code execution results, and web search outputs, the summarization model 119 can generate a standardized data structure that includes consistent metadata for all outputs. The metadata may include visibility flags indicating whether corresponding reasoning tokens or tool-call responses are designated as displayable outputs on the user interface 103 or protected intermediate reasoning. This approach ensures that user-facing interfaces receive coherent, properly formatted summaries while preventing disclosure of sensitive internal reasoning artifacts.

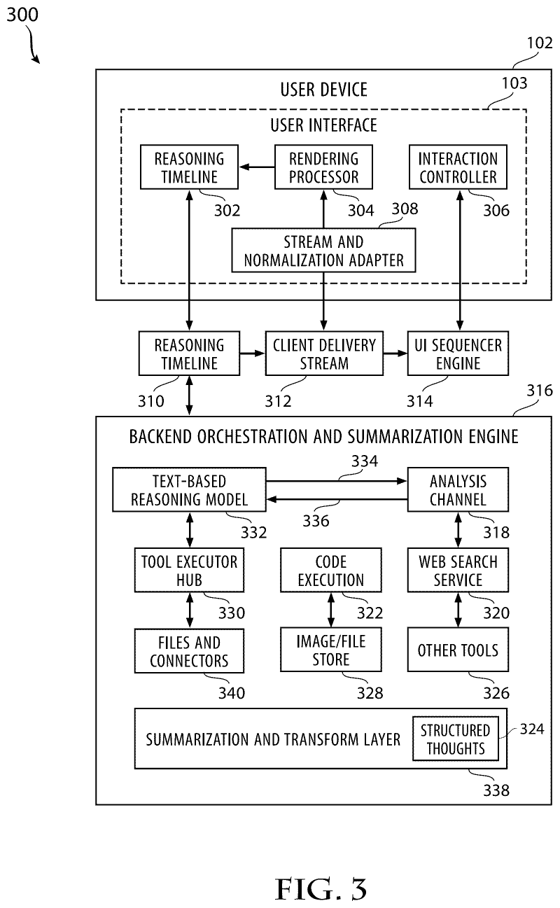

With respect to the concept of protected intermedia reasoning, in various embodiments, the system can provide multiple logical communication channels to manage outputs generated by the CoT reasoning model 127 and associated tool calls. Among these, an analysis channel 318 (See FIG. 3) can be used to handle sensitive intermediate reasoning outputs, including raw reasoning tokens and internal tool-call results. The analysis channel 318 functions as a protected workspace where the CoT reasoning model 127 can freely generate exploratory reasoning, manipulate multimodal inputs, execute code, perform searches, or integrate retrieved data without exposing these intermediate outputs to a user-facing interface. By isolating these unfiltered reasoning artifacts within the analysis channel 318, the system ensures that sensitive “secret sauce” operations, experimental branches of reasoning, or raw model tokens remain secure and do not persist in client-visible memory. In some cases, data associated with the analysis channel 318 (or any other channel) may be persistent under certain circumstances.

The approach can include channel separation for multimodal integration. In addition to the analysis channel 318, the system may assign other logical channels for processing specific data types or output categories. For example, display channels may be used to surface sanitized, structured outputs such as step summaries (reported as the summarization output 108), search citations, image manipulations, or code execution results intended for presentation to a user. The CoT reasoning model 127 can direct outputs into these channels based on data type, while the summarization model 119 further processes information from the analysis channel 318 to produce safe, contextually coherent results suitable for display. By separating internal reasoning streams from client-facing outputs, the system supports parallel multimodal workflows—for example, buffering in an ordered message queue 125 search results in one channel, aggregating reasoning tokens in another, and generating visual outputs in a third—while maintaining control over visibility and safeguarding sensitive intermediate reasoning.

Communication between the reasoning model and the analysis channel 318 can be bidirectional, supporting both feedback from tool-call results to the model and real-time reasoning updates from the model to the analysis channel 318.

Summarization model 119 (or the context management service 116) can preserve contextual continuity across multi-step reasoning processes. In some aspects, the summarizing operations reference previously generated summaries when producing a subsequent step summary, allowing the summarization model 119 to maintain coherence and alignment with prior reasoning stages. For example, when reasoning about uploaded documents such as an attachment 106, and subsequently retrieving supporting web citations, summarization model 119 integrates earlier summarized results into later outputs. This capability ensures that the generated summaries are not isolated fragments but instead form a unified, logically consistent narrative across multiple stages of the reasoning process.

The system can perform formatting and presentation optimization of the response 110 to prompt 104. Summarization model 119 can further adapt the style, verbosity, or formatting of its outputs based on client-specific rendering policies or user preferences. For example, in one aspect, the summarization model 119 produces concise summaries optimized for mobile interfaces, while in another embodiment, it generates detailed reports suitable for enterprise integrations. The structured outputs may include a variety of message types, such as structured thoughts, search citations, tool-call results, and multimodal visualizations, enabling flexible integration into a wide range of user experiences and downstream applications.

In summary, summarization model 119 serves as an intelligent orchestration layer that transforms raw, unstructured reasoning tokens and tool-call responses into sanitized, structured, and contextually accurate insights. Its capabilities include (i) asynchronous summarization for improved responsiveness, (ii) dynamic chunking for adaptive performance, (iii) structured step summaries for improved client-side rendering, (iv) normalization and metadata generation for consistent multimodal handling, (v) contextual continuity across reasoning stages, and (vi) formatting flexibility for optimized presentation. Collectively, these features enable summarization model 119 to deliver low-latency, reliable, and user-ready outputs while protecting sensitive intermediate reasoning processes and maintaining compatibility across diverse client environments.

Context management service 116 can, as noted above, maintain contextual continuity across multi-step reasoning processes. Context management service 116 can also route prompts and responses through a moderation system 128, which can include prompt safety system 132. In some aspects, prompts are provided to prompt safety system 132 before being provided to AI model(s) 126. Prompt safety system 132 is configured to use one or more techniques to evaluate prompts (i.e., the prompt 104, attachment 106 and/or any additional prompts) to ensure a prompt is not requesting AI model(s) 126 to generate moderated content. In some aspects, prompt safety system 132 can utilize text pattern matching, classifiers, and/or other AI techniques.

Context management service 116 can also include a prompt service 122 that can modify, suggest, correct, create or otherwise manage the prompt 104 and/or any other prompts obtained from a user. The prompt service 122 may further refine the prompt 104, the attachment 106 or other prompts from within the generative response engine 112 as well as part of the context management service 116.

Conversation metadata 124 can aggregate data points relevant to the conversation, including prompt 104, an action service 118 (or tool call orchestration service), and personalization state 120. A consolidated information package can serve as the input for AI model(s) 126. Conversation metadata 124 can label parts of a prompt as user-provided, AI model-provided, a system prompt, personalization state 120, data from action service 118, obtained from the prompt 104, the attachment 106, or tool 134 (addressed below).

AI model(s) 126 are the core engines that process inputs (from context management service 116) and generate outputs. In some aspects, AI model(s) 126 may be a generative transformer or an autoregressive transformer, but could use other architectures. The transformer is a multimodal transformer that can use audio tokens (or embeddings thereof), visual tokens (or embeddings thereof), and language (or embeddings thereof) as needed.

A feature of AI model(s) 126 is to generate content in response to the prompt 104 and/or the attachment 106, as well as optionally any other data, such as from uploaded files. AI model(s) 126 can be configured to receive inputs via API(s) 114 that guide a desired output. AI model(s) 126 can analyze the input, identify relevant patterns and associations in the data, and generate a sequence of tokens predicted as the most likely continuation of the input. AI model(s) 126 generate responses by sampling from the probability distribution of possible tokens, guided by the patterns observed during its training. Two features of the autoregressive transformer that result in this functionality are that it might use the decoder part of the transformer architecture and utilize self-attention. Using the decoder part of the transformer architecture, the transformer focuses on predicting the tokens given the previous context tokens. And the self-attention mechanism captures long-range dependencies amongst tokens, allowing it to generate contextually relevant responses (in text, audio, images, and video).

In some aspects, AI model(s) 126 can generate multiple possible responses before presenting the final one. AI model(s) 126 can generate multiple responses based on the input, and these responses are variations that AI model(s) 126 consider potentially relevant and coherent.

In some aspects, AI model(s) 126 can evaluate generated responses based on certain criteria. These criteria can include relevance to the prompt 104, the attachment 106, coherence, fluency, and sometimes adherence to specific guidelines or rules, depending on the application. Based on this evaluation, AI model(s) 126 can select the most appropriate response. This selection typically scores highest on the set criteria, balancing factors like relevance, informativeness, coherence, and content moderation instructions/training.

In some aspects, an instruction provided by an API(s) 114, a system prompt, the prompt 104, the attachment 106 or a decision made by AI model(s) 126 can cause AI model(s) 126 to interpret the prompt 104 and/or the attachment 106 and re-write it or improve the prompt 104 or the attachment 106 for a desired purpose. For example, AI model(s) 126 can determine to take the prompt 104 or the attachment 106 to make a picture and enhance one or more of the prompts, to yield a better picture. In these instances, AI model(s) 126 can generate their own prompts, which can be provided to tool 134 or provided to AI model(s) 126 to yield a better output response than the original prompt might have. In some aspects, the prompt 104 may or may not be provided to the AI model(s) 126 to generative response engine 112 and interrupt an active inference trajectory.

AI model(s) 126 can also do more than generate content in response to the prompt 104 and/or the attachment 106. In some aspects, AI model(s) 126 can use decision boundaries to determine the appropriate course of action based on the prompt. In some examples, a decision boundary might be used to cause the AI model(s) 126 to recognize that it is being asked to respond in a particular format, such that the AI model(s) 126 will generate its response constrained by the particular format. In some examples, a decision boundary can cause the AI model(s) 126 to refuse to generate a responsive output if the decision is that the responsive output would violate a moderation policy. Data from the attachment 106 may guide the decision.

In some examples, the decision boundary might cause the AI model(s) 126 to recognize that it interfaces with another AI model(s) 126 or application to respond to the prompt 104 and/or the attachment 106. For example, when the AI model(s) 126 is a model that does not have multimodal capabilities, it might recognize that it is being asked to output an image, and therefore, it needs to interface with a model that can output images to respond to the prompt 104.

In another example, the prompt 104 and/or the attachment 106 might request a search of the Internet before responding. The AI model(s) 126 can use a decision boundary to recognize that it should conduct a search of the Internet in connection with the prompt 104 and use the results of that search to respond. In another example, the prompt 104 and/or the attachment 106 might request that the AI model(s) 126 take an agentic action on behalf of the user by interacting with a third-party service (e.g., book a reservation for me at . . . ), the tool 134, and the AI model(s) 126 can use a decision boundary to recognize that it needs to plan steps to locate the third-party service, contact the third-party service, and interact with the third-party service to complete the task. The AI model(s) 126 can report back to the user that the action has been completed. Any of these actions or requests may further be guided by the attachment 106 and the analysis of the contents of a document.

When AI model(s) 126 can determine to take an agentic action on behalf of the user or to call a tool 134 to provide a quality response to the user account, AI model(s) 126 might call tool 134 or cause an action to be performed by action service 118. As indicated above, tool 134 can include internet browsers, editors such as code editors, other AI tools, etc. An action service 118 can cause an action to be performed, perhaps using tool 134. As used herein, an action performed by action service 118 should be considered to cover a broad array of actions that AI model(s) 126 can perform with or without tool 134. Tool 134 covers various services and software encompassing tools such as a computer operating system, so that AI model(s) 126 can control the computer operating system on the user's behalf, to robotic actuators, to search browsers, image manipulation tools, audio tools, video tools, other AI systems, and specific applications.

In some aspects, the output of the AI model can be further analyzed by output safety system 130. While AI model(s) 126 can perform some of their own moderation, there can be instances where it is beneficial to have another service review outputs for compliance with a moderation policy.

As used herein, the present description may refer to the generative response engine or AI model(s) 126 deciding or reasoning prior to responding to the prompt 104. Determining can refer to a process by which an AI model(s) 126 outputs a response that provides a conclusion. For example, an AI model(s) 126 can perform an inference operation to output a sequence of tokens, which provides a determination. In such an example, the AI model(s) 126 might not have made any decision other than to sample particular tokens to provide an output, yet the response from the AI model(s) 126 might be a statement of determination. In another example, AI model(s) 126 can be trained to make particular determinations. In such examples, the AI model(s) 126 can be trained to make a decision, such as to cross a decision boundary, take an agentic action or to call a tool 134, etc. Each action can be guided further by data from the prompt 104 and/or the attachment 106 shown in FIG. 1.

Reasoning simulates logical processes to draw conclusions or perform tasks based on provided inputs and learned information. Although the AI model(s) 126 might lack true understanding, they use pattern recognition and linguistic associations to emulate reasoning by linking related concepts and predicting outcomes. As used herein, the term reasoning by an AI model(s) 126 refers to the process performed by AI models known as reasoning models.

Generative response engine 112 can be one or more AI models and other components configured to handle personalization, summarization, buffering in an ordered message queue 125, moderation, conversations, etc. AI model(s) 126 may be part of generative response engine 112, where generative response engine 112 may include one or more components for supporting interaction with AI model(s) 126.

API(s) 114 can accept structured requests containing data packages that can include prompts, context information from an application, files, user identification, historical information, and/or configuration parameters. For example, API(s) 114 can be used to provide prompts and divide the prompt 104 into one or more of: system prompts, user prompts, and context information. In some aspects, API(s) 114 can provide specific inputs for which generative response engine 112 is configured to respond with a specific behavior. For example, API(s) 114 can be used to specify that it requires an output in a particular format or a structured output. The particular format or structured format can relate to a context type or context information or to a context type (i.e., text, images or video) in connection with the prompt 104. For example, in a chat completion API, the API call can specify parameters for the output, such as the max length for the desired output, and specify aspects of the tone of the language used in the response.

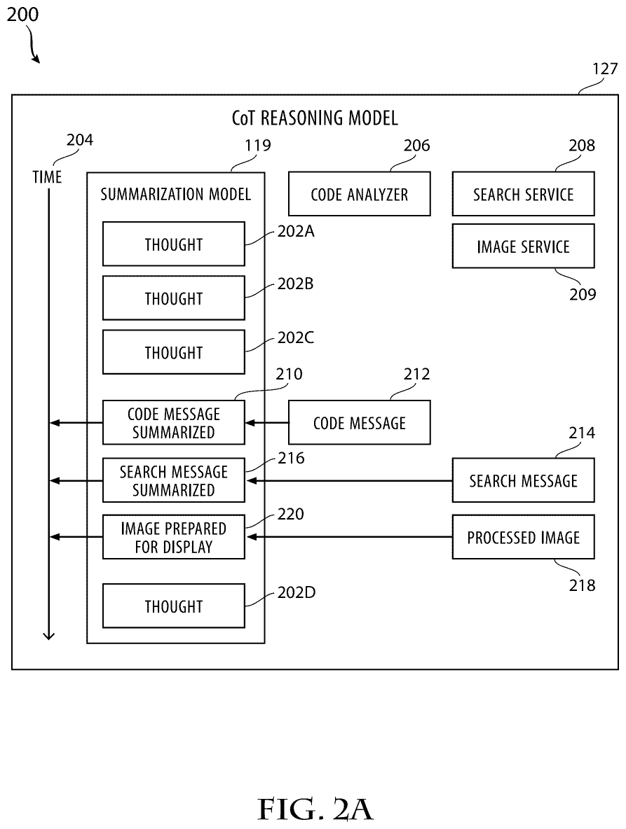

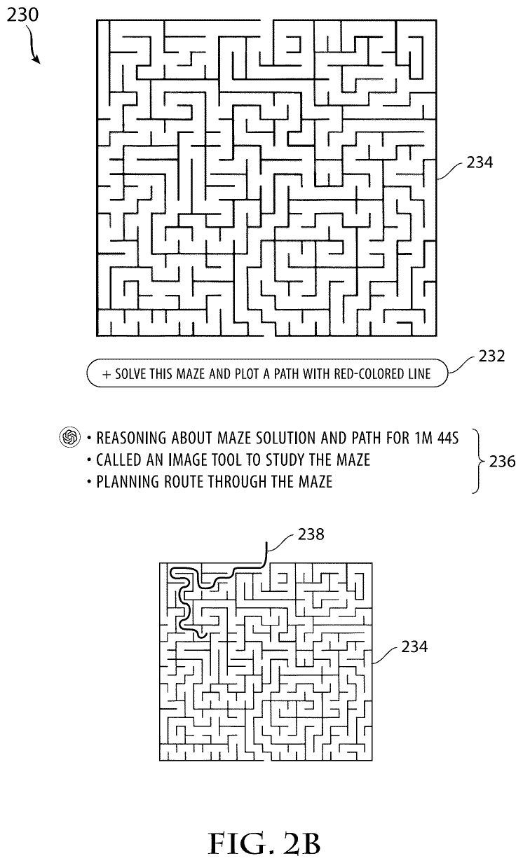

FIG. 2A illustrates an example sequence 200 including additional details about the CoT reasoning model 127. The system can include summarization model 119, a thought 202A, a thought 202B, a thought 202C, a thought 202D, a reasoning timeline 204, a code analyzer 206, a search service 208, a code message summarized 210, a code message 212, and a search message 214 and a search message summarized 216. The code analyzer 206 and search service 208 are examples of a tool 134 that can be called to process data.

FIG. 2A illustrates an example sequence 200 of multimodal chain-of-thought reasoning. The example sequence 200 depicts a progression of reasoning and tool-invocation events generated by a text-based reasoning model during execution of a task. CoT reasoning model 127 generates thoughts 202A-202D, which may represent internal chain-of-thought steps expressed as text tokens. In some aspects, CoT reasoning model 127 could be a chain-of-thought reasoning model, or could be other types of AI models.

Summarization model 119 receives thoughts 202A-202D and produces user-facing condensed outputs suitable for presentation in a user interface 103, while removing sensitive or extraneous content from the raw chain of thought. The summarization model 119 may operate asynchronously so as not to delay other tool outputs.

Certain thoughts trigger specialized tool invocations. For example, code analyzer 206 processes reasoning steps that generate code. In response to such steps, the system produces code message summarized 210 when the code output is passed through summarization model 119, or code message 212 when provided without summarization for lower-latency display. Code analyzer 206 may execute code for tasks such as data processing, problem solving, or image manipulation, and may surface execution results in real time.

Similarly, search service 208 processes reasoning steps that invoke a search tool. Search message 214 represents structured search results, such as search queries and corresponding website citations, generated in response to a search invocation. In some aspects, search message 214 is delivered to the user device 102 without summarization to permit immediate rendering of live search progress, including websites being read and search terms issued.

Reasoning timeline 204 represents the temporal sequence of reasoning and tool outputs. Over time, thoughts 202A-202D are interleaved with tool messages, allowing the user interface to display an integrated, type-aware reasoning timeline as summarization output 108. The arrangement in FIG. 2A highlights that the model's reasoning is not limited to text: reasoning steps may invoke multimodal operations, such as executing code or performing web searches, whose results are streamed back into the reasoning context and rendered alongside textual thoughts.

In some aspects, the system orchestrates these heterogeneous outputs using an ordered message queue 125 (shown in FIG. 1) that maintains sequence while accommodating asynchronous summarization. The architecture enables a real-time, per-type rendering strategy in which text thoughts, code outputs, and search results are displayed with pacing and visual treatments optimized for user comprehension and trust. According to one of the concepts introduced above, this disclosure also includes processes for presenting intermediate reasoning steps of a multimodal reasoning model, such as CoT reasoning model 127 or generative response engine 112, in real time. This concept focuses on real-time visualization of the reasoning process to enhance interpretability and user trust. Intermediate reasoning steps, tool-call directives, and outputs are streamed as structured UI cards or visual objects along a reasoning timeline. Summarization model 119 can curate outputs, combining textual reasoning, processed images, annotations, and search results into cohesive snapshots. Users can observe the model's evolving thought process, improving transparency, auditability, and debugging. The system adapts display formats and durations dynamically depending on the content type.

In one example, a user device 102 receives, from a server, a plurality of reasoning messages generated during execution of a multimodal reasoning process by generative response engine 112 and associated components, including a CoT reasoning model 127, summarization model 119, image service 209, search service 208, and code analyzer 206. Each reasoning message includes metadata identifying its message type, which may represent at least one of a text output, an image output, a search result, or a code execution result.

For example, if a user submits a prompt 104 requesting: “Detect all vehicles in this image, retrieve related data, and summarize findings,” the server may generate multiple reasoning messages such as a text-based description of detected objects, a processed image 218 highlighting detected vehicles, a set of search results retrieved from the search service 208, and a code execution result produced by a code analyzer 206 to classify vehicle models based on image data. These reasoning messages collectively represent the evolving reasoning process that will be rendered to the user along the reasoning timeline 204.

Upon receiving the reasoning messages, the system determines a presentation format for each message based on its message type. The presentation format can specify visual styles, animation sequences, and display durations tailored to each artifact type. For example, textual reasoning steps may appear as structured conversational cards or processed image 218 may be displayed with highlighted bounding boxes or annotations generated by the image service 209. An image prepared for display 220 may be provided. Other examples can include search results from the search service 208, which may be animated for staged arrival, sequentially showing search citations, website titles, or other retrieved artifacts. Code execution results may present outputs from the code analyzer 206 alongside descriptive reasoning tokens in natural language.

The flexible formatting ensures that multimodal artifacts are presented cohesively and remain easy to interpret within the summarization output 108.

The system renders the plurality of reasoning messages along a reasoning timeline 204 according to their respective presentation formats. The reasoning timeline 204 visually represents the progression of reasoning steps, including intermediate outputs and contextual artifacts, in chronological order.

In some aspects, the reasoning timeline 204 supports two display modes. For example, a collapsed mode can cause the system to display only the most recent reasoning message, maintaining a compact interface focused on the current step. In the collapsed mode, the user interface 103 displays only the most recent card while maintaining a complete reasoning log, whereas in expanded mode, all reasoning steps remain visible and update dynamically. An expanded mode may cause the system to display all reasoning messages along the reasoning timeline 204, allowing users to inspect the complete reasoning sequence for full transparency.

While processing a prompt 104 that requires multiple stages of image manipulation, code analysis, and external data retrieval, the expanded mode may allow the user to view every intermediate image, such as processed image 218, search citation, and code output, as the reasoning process unfolds.

When the reasoning messages include processed image 218 generated by the image service 209 or an associated image-processing tool, the images can be displayed within the reasoning timeline 204. The processed images may comprise manipulated outputs, such as cropped regions, rotated images, contrast-adjusted versions, or annotated overlays highlighting detected objects or areas of interest.

In some aspects, if the CoT reasoning model 127 determines that only a specific region of the image is relevant, the image service 209 may output a cropped view that zooms into that region, improving interpretability. Similarly, the generative response engine 112 may invoke annotation overlays to highlight specific objects detected in the image, visually aligning intermediate insights with textual reasoning steps.

Another concept disclosed herein relates to sequencing and animations. The system can apply message-type-dependent sequencing rules to control pacing and ordering when rendering reasoning messages. For example, search results from the search service 208 may be displayed in a staged arrival animation, where citations, website titles, and retrieved summaries appear sequentially to mimic live retrieval.

Similarly, when presenting manipulated images such as processed image 218, the system may animate overlays or highlights as they are applied, showing how different regions are progressively analyzed. The system synchronizes transitions between displayed reasoning messages with the completion of their associated animations, providing a smooth, coherent presentation experience. The system may present in image prepared for display 220 by the summarization model 119.

The system may display progress indicators associated with active tool executions, improving transparency when multiple services contribute intermediate artifacts. Examples of such presentations can include a website reading progress. At the same time, results are retrieved from the search service 208 or a code execution status indicator for operations performed via the code analyzer 206. Another example can include image-processing completion markers when manipulations are performed by the image service 209. These indicators allow users to follow asynchronous processing steps in real time and anticipate upcoming updates to the summarization output 108.

To distinguish active reasoning outputs within the reasoning timeline 204, the system can apply visual emphasis effects such as background blurring, border highlighting, region shading, or contrast adjustments. For example, when new images such as processed image 218 are displayed, the surrounding UI regions may temporarily blur to direct user attention toward the updated artifact. Similarly, search citations or code execution results may be highlighted when first introduced, ensuring that key information stands out within the evolving summarization output.

The presentation format may be optimized using empirically derived display durations to balance user comprehension with perceived responsiveness. For example, textual reasoning messages may appear for shorter durations, while messages containing annotated images or search results remain visible longer to accommodate the increased cognitive load. These optimized timings ensure that users can follow the reasoning timeline 204 and the associated output, such as summarization output 108, effectively without being overwhelmed or slowed down unnecessarily. In some aspects, display durations for UI cards are determined empirically to balance comprehensibility with responsiveness.

In some aspects, the system dynamically interleaves textual reasoning outputs with multimodal artifacts, including processed image 218, search citations, and code execution results, within a reasoning timeline 204. For example, as the CoT reasoning model 127 generates reasoning tokens, the system may insert retrieved search snippets and generated annotations inline, producing a unified narrative of the reasoning process in real time.

This integration enables the summarization output 108 to combine natural-language reasoning, external search context, manipulated images, and executed code outputs into a cohesive, continuously updated representation of the model's thought process.

The reasoning timeline 204 is updated dynamically as additional reasoning messages are generated, ensuring that users have continuous visibility into the evolving reasoning process. As new messages arrive, previously displayed reasoning steps remain visible, and the interface adjusts automatically to incorporate updated images such as processed image 218, search results, or code outputs. Thus, a real-time or near-real-time approach can be used to update additional reasoning messages dynamically.

For example, suppose a search service 208 still retrieves website citations while an image service 209 completes an annotation overlay. In that case, the reasoning timeline 204 immediately incorporates the updated annotated image without waiting for the search results, maintaining a fluid and transparent presentation of intermediate reasoning steps.

These techniques enable a multimodal reasoning system, including the generative response engine 112, CoT reasoning model 127, summarization model 119, image service 209, search service 208, and code analyzer 206, to present intermediate reasoning steps along a reasoning timeline 204 in real-time. By tailoring presentation formats based on message types, animating staged arrivals, synchronizing transitions, highlighting key artifacts, and interleaving multimodal reasoning outputs into a unified display, the methods deliver a transparent, responsive, and context-rich user experience.

FIG. 2B illustrates an example user interface 230 that includes a maze 234 provided to generative response engine 112 with an instruction to solve the maze 232, per some aspects of the present technology. Generative response engine 112 can enable the ability to analyze and process the maze 234 to generate an output according to the instructions, including the maze solution and a plot showing the path through the maze. This figure provides an example of instruction visualization where the system can overlay a red path on top of the maze 234 to visually represent the computed solution while providing a textual rationale in the summarization output 108.

To illustrate the graphical information that may be provided about the chain-of-thought reasoning, FIG. 2B illustrates reasoning output 236, including reports such as “reasoning about a maze solution and path for 1 m 44 s” and later reporting: “Called an image tool to study the maze”. The reasoning output 236 can include a report of: “Planning a route through the maze” and show an interim route 238 in the maze 234 as part of the reasoning output 236. FIG. 2B illustrates some examples of how the thought pattern of generative response engine 112 can be visualized for the user.

FIG. 3 illustrates an example system 300 for orchestrating and presenting multimodal chain-of-thought reasoning, according to some embodiments. System 300 includes a user device 102 interacting via user interface 103. User interface 103 includes reasoning timeline 302, rendering processor 304, interaction controller 306, stream and normalization adapter 308, reasoning timeline 310, client delivery stream 312, and UI sequencer engine 314. These components can be a client component configured on user device 102 for performing operations based on instructions and/or data received from backend orchestration and summarization engine 316. The client or user interface 103 can represent a front-end on the user device 102 to generative response engine 112. Backend orchestration and summarization engine 316 includes analysis channel 318 (which can represent a number of different channels used for reasoning that can isolate different reasoning threads), web search service 320, code execution 322, structured thoughts 324, other tools 326, image/file store 328, tool executor hub 330, text-based reasoning model 332, raw reasoning and tool calls 334, tool feedback 336, summarization and transform layer 338, and files and connectors 340. In some aspects, FIG. 3 illustrates in more detail aspects of summarization model 119 as shown via backend orchestration and summarization engine 316 and related components.

In some embodiments, system 300 provides end-to-end processing and presentation of multimodal reasoning steps produced by a text-based reasoning model 332. User device 102 interacts with user interface 103 to provide prompts, images, files, or other inputs. User interface 103 presents intermediate and final reasoning outputs within reasoning timeline 302.

Rendering processor 304 formats messages for display according to their type, applying styles, layouts, and animation effects. Interaction controller 306 manages user interactions with reasoning timeline 302, including switching between collapsed and expanded views, scrolling, and pausing live updates. Stream and normalization adapter 308 parses incoming message envelopes, applies data normalization across modalities, and retrieves referenced image or file segments from image/file store 328.

Reasoning timeline 310 stores normalized reasoning steps for visual presentation. Client delivery stream 312 transmits ordered, type-tagged messages to user interface 103. UI sequencer engine 314 controls timing and sequencing of message presentation based on message type, applying pacing rules and coordinating animation timing.

Backend orchestration and summarization engine 316 manages reasoning data flow from text-based reasoning model 332 to user interface 103. Analysis channel 318 carries raw reasoning and tool calls 334, which may include sensitive content not shown directly to the user. Web search service 320 executes model-initiated search queries and returns search results, including read-progress metadata. Code execution 322 runs code produced by text-based reasoning model 332, including scripts for image manipulation and self-verification. Structured thoughts 324 represent summarized text reasoning outputs generated by summarization and transform layer 338. Other tools 326 provide additional capabilities such as file search or retrieval-augmented generation. Image/file store 328 holds blob-addressable media or document assets referenced in reasoning steps. Tool executor hub 330 routes function calls from text-based reasoning model 332 to appropriate tool services.

In some aspects, summarization model 119 can generate the structured thoughts 324 as structured step summaries including such information as one or more of a title indicative of a reasoning step and a description formatted for client-side parsing. A step summary can be a structured message including multiple message types, including one or more structured thoughts 324, search citations, tool-call results, or multimodal visualizations. Structured thoughts 324 can encompass any of these types of data. Tool-call responses from tool 134 can include search results, code execution outputs, or image manipulations. Summarization model 119 can format these responses as structured outputs for display as part of structured thoughts 324.

Further, the system can assign, via backend orchestration and summarization engine 316, reasoning tokens and tool-call responses to logical channels. Analysis channel 318 provides one example of such logical channels, while other channels may exist as well. Analysis channel 318 or other channels can be used for intermediate reasoning. At least one display channel can also be used for sanitized summaries and for displaying structured multimodal data, such as structured thoughts 324.

Text-based reasoning model 332 produces multimodal chain-of-thought reasoning steps and tool invocations, which are captured as raw reasoning and tool calls 334. Tool feedback 336 represents outputs of invoked tools, which are fed back to text-based reasoning model 332 for continued reasoning. Summarization and transform layer 338 generates user-safe summaries for text outputs, transforms non-text outputs into structured formats, and applies buffering and delta-based gating to manage latency and message ordering. Files and connectors 340 enable access to external repositories such as cloud storage services, messaging platforms, or code repositories.

The concept of buffering reasoning tokens can occur until a delta threshold is satisfied. For example, the system may delay releasing intermediate reasoning tokens until a token count delta threshold is met. The delta threshold may relate to a difference in token count between consecutive messages. Suppose the CoT reasoning model 127 generates one-hundred twenty tokens of reasoning text, but the delta threshold is set to fifty tokens. When the first fifty tokens are produced, the system buffers them rather than immediately presenting them to the user interface 103. Once at least fifty tokens are available, the system releases them together as a chunk to the summarization model 119 or directly to the user interface 103. This approach reduces the likelihood of showing fragmented or incomplete reasoning and improves readability.

In another example, if a reasoning model generates one-hundred twenty tokens but a delta threshold of fifty tokens is configured, the first fifty tokens are buffered until the threshold is reached, then released together for summarization. If generation slows, a one second time threshold ensures the interface still updates without gaps. This improves perceived responsiveness while preserving coherence.

The delta threshold can also be based on an elapsed time threshold between message releases. The delta threshold in this regard may be based on elapsed time rather than token count. The system may be configured to release buffered reasoning tokens every seven hundred and fifty milliseconds regardless of how many tokens have been generated. This ensures that the user sees progressive updates without excessive latency, even if the CoT reasoning model 127 generates tokens slowly. Time-based thresholds are particularly useful when maintaining a responsive, streaming-style interface.

In a hybrid approach, the delta threshold may combine token count and time duration to balance responsiveness and readability. For instance, the system could release tokens when either: ≥50 tokens are available, or one second has passed since the last release. If the reasoning model generates tokens rapidly, chunks of fifty are streamed out quickly. If generation slows, the user still receives periodic updates to avoid perceived “freezing” in the interface. The hybrid approach provides smooth, low-latency interactions while preserving coherent thought boundaries.

In advanced implementations, the delta threshold can be adaptive. If the user device 102 has limited bandwidth or high latency, the delta threshold may increase to reduce network load. If summarization model 119 detects that the reasoning step involves rapid context changes, it can lower the delta threshold so updates appear sooner to maintain contextual continuity. Adaptive thresholds ensure the interface is resource-aware and optimizes user experience dynamically.

In operation, system 300 maintains ordered delivery of reasoning outputs to user interface 103 while mixing asynchronous summarization results with synchronous tool outputs. This architecture allows real-time, type-aware presentation of multimodal reasoning steps in a manner that is transparent, comprehensible, and latency-optimized.

In some aspects, generative response engine 112 can operate as a multimodal reasoning model that runs a turn of conversation with a user. While it thinks, it emits a stream of heterogeneous “reasoning messages” (text thoughts or structured thoughts 324, tool calls/results such as through code execution 322, web search service 320, tool 134, other tools 326, code outputs, image snippets) into a hidden analysis channel such as analysis channel 318.

The backend orchestration and summarization engine 316 can summarize/sanitize the text thoughts, pass through non-text artifacts with light transforms, preserve ordering/latency with the ordered message queue 125, and stream a type-aware feed to the user interface 103 on the user device 102. The user interface 103 renders a reasoning timeline with per-type pacing, animations, and views so users can track what generative response engine 112 is doing in real time without overload or too much information to the user during the reasoning process.

Generative response engine 112 can be natively multimodal in that it reasons over text and images such as through attachment 106, and decides when to call a tool 134 (i.e., via web search service 320, code execution 322, or a file search from an image/file store 328). These raw steps are provided to the analysis channel 318. In some aspects, data associated with the analysis channel 318 is not persisted or maintained after the turn in the conversation. Not maintaining the analysis channel can protect sensitive reasoning while enabling the information provided for the live user experience. In other aspects, such data may persist or be maintained based on user permissions or other factors.

In some aspects, calls to the tool 134 or other tools 326 can be made through tool executor hub 330. For example, a web search via web search service 320 can return queries, page titles, and read-progress signals. A Python runtime can execute code via code execution 322 in which generative response engine 112 writes, including image manipulation (crop/zoom/rotate/contrast) and test/verification snippets. The results can re-enter a context of the reasoning process and the analysis channel 318.

Backend orchestration and summarization engine 316 can provide both summarization and modality transforms. For example, text thoughts can be brief summaries of a current state of analysis by generative response engine 112. Text thoughts can be summarized asynchronously into a structured format (e.g., title +summary) as structured thoughts 324 using chunking with dynamic sizes (first chunk small, later chunks larger), guided by buffering/delta thresholds (by time/length) to keep latency low and updates smooth. When using tool 134 of any of the tools disclosed in FIG. 3, non-text artifacts (search results, image variants/regions of interest, code/test outputs) can be transformed synchronously into predictable objects the user interface 103 can render. In some cases, no summarization would be required for rendering such non-text artifacts.

At the end of a conversation turn, the system 300 can generate a reasoning recap, which can be an executive summary of the full chain or full conversation with the user.

Ordered message queue 125 shown in FIG. 1 can keep original sequences intact while allowing text summarization as described above to finish out of band. In some aspects, only “finished” items are yielded, meaning that they are produced and presented on the user interface 103. This prevents blocking on summaries yet avoids reordering. Yielding can observe delta thresholds so the stream of data presented to the user on the user interface 103 feels continuous, not choppy. In other words, a respective finished summary that is presented on the user interface 103 can be evaluated and determined to be not too different from or conceptually remote from a previous finished summary. Stream and normalization adaptor 308 can be one mechanism to implement yielding with delta thresholds.

Messages can be emitted over a type-aware delivery stream (e.g., SSE/WebSocket) with metadata so the user interface 103 or client knows exactly how to render each item via rendering processor 304.

Stream and normalization adaptor 308 can perform asset retrieval in connection with managing a client boundary associated with user interface 103. Stream and normalization adapter 308 can parse envelopes and fetch referenced blobs by an identifier (e.g., image tiles/variants from a blob store) without client-side cropping. The approach can keep rendering deterministic and efficient.

The user interface 103 can include reasoning timeline 302 which can have, for example, two modes. A first mode can be a collapsed mode which shows only the most recent message for a calm, live “heartbeat,” preventing overload. A second mode can be an expanded mode in which every step in a sequence is shown for full transparency and auditability. Rendering processor 304 can include a type-specific renderer that applies styles, layouts, and components. For example, text can include a token-like fade-in, then a short pause. Images can be rendered to show cropped/zoomed regions or manipulated variants with slightly longer dwell to support visual comprehension. Search results can be displayed through staged “pills” for queries/citations with live read indicators. When code is shown, it can be presented in snippets, stdout/stderr, and self-tests as the model verifies its own work.

User interface 103 interact with a UI sequencer engine 314 that performs UI animation/sequencer orchestration per-type pacing (e.g., ~200 ms after a final text token, ~400 ms after an image) and transitions the presentation of data on user interface 103 (fade-in, staged arrivals) so heterogeneous updates feel cohesive. These values were tuned empirically to balance responsiveness with readability.

Several unique aspects to the front-end aspect of FIG. 3, including operations by the client or user interface 103 and associated components can include improvements to the user experience. A visual language and interaction model implements live, per-type, paced rendering (i.e., via different modes for collapsed vs. expanded timelines; staged search animations; ROI highlighting; progress badges), designed to increase trust without overwhelming users.

The improvements provided by backend orchestration and summarization engine 316 can include the analysis-channel architecture, asynchronous text summarization with dynamic chunking, buffering/delta gating, and the ordered message queue 125 that preserves a sequence while mixing summarized text with synchronous tool outputs under tight latency constraints.

The disclosed approach further provides privacy and safety for the user. Raw analysis tokens can be hidden (i.e., by being non-persistent) and only sanitized summaries and selected tool artifacts are streamed to the user device 102. This gives transparency into what happened or what is happening with generative response engine 112 without exposing the model's sensitive internals.

The approach disclosed herein can utilize new tools such as retrieval-augmented generation (or RAG) and file connectors. RAG involves analyzing a user's prompt for possible reformulation to make it more “search-friendly.” A retrieval layer is implemented to query an external knowledge source, such as a vector database (e.g., Pinecone, Weaviate, FAISS); an enterprise document store (e.g., Google Drive, Confluence, Slack); or the web. The retrieved chunks are ranked based on relevance. A generation layer is used to process the retrieved content via a model alongside the user's question, typically through the context window or a tool call. The model then generates an answer that is more accurate (grounded in retrieved facts), more up-to-date and often citation-friendly.

A file connector is an integration between an AI assistant like generative response engine 112 and an external data source—like Google Drive, Dropbox, OneDrive, SharePoint, Confluence, Notion, Slack, or a company's document management system. The file connector allows generative response engine 112 to search, retrieve, and reference files stored there in real time. A file connector is essentially a bridge between generative response engine 112 and the user's documents. By default, generative response engine 112 has a knowledge cutoff and no direct access to private files or cloud storage. A file connector solves this by indexing documents in a chosen data source. Generative response engine 112 can be granted permission to search and retrieve relevant chunks from those documents. File connector can feed the retrieved content into the context window for retrieval-augmented generation.

For example, if a Google Drive connector is enabled, the user can ask a question like: “Summarize the main findings of our August compliance audit.” The file connector can search the user's drive and query the drive using vector search and metadata filters. The file connector can retrieve relevant chunks. For example, it might pull three PDFs and extract only the relevant sections. The model can generate an answer by using those chunks to create an accurate, grounded response—and can even cite sources.

These new tools and new modalities can plug into the same existing processing lanes and can perform, for example the following flow of processes: The system can emit raw messages, and then transform/summarize the message and provide them to the ordered message queue 125. The system can then stream queued messages and render them with a new type-specific component. These new tools can fit within existing architecture so that no fundamental changes to the AI model(s) 126 in generative response engine 112 are required.

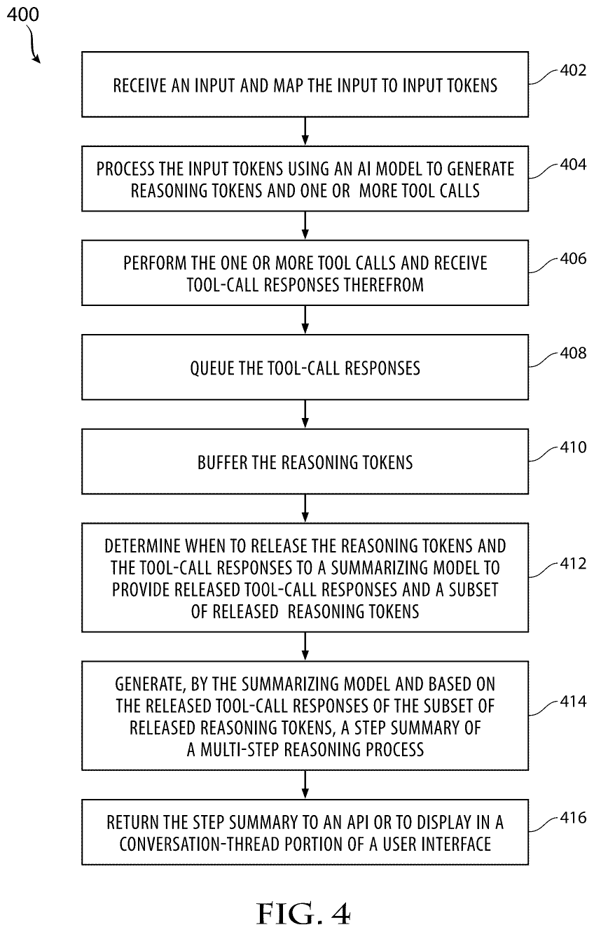

FIG. 4 illustrates an example method 400 of operating a backend orchestration and summarization engine 316 as part of a generative response engine 112. The method 400 relates to a system implementing improvements on the generative response engine 112 to think with images such as attachment 106 and how the system modifies the CoT reasoning model 127. The CoT reasoning model 127 is modified to use multimodal inputs (e.g., text, images, and file search) and outputs (e.g., text, images, web search results, and python code). Further, the method 400 provides an approach to augmenting the thinking process by enabling tool calls (e.g., calling tool 134 to provide for image manipulation, image generation, web search, file search, and generating and executing python code). These enhancements improve the capability of the generative response engine 112 to handle complex, multimodal reasoning tasks.

Method 400 can be performed by a system. The system can consist of one or more user devices such as user device 102, a tool 134, a generative response engine 112, AI model(s) 126, summarization model 119, CoT reasoning model 127, ordered message queue 125, backend orchestration and summarization engine 316, a computing system 700, a processor 704 and/or any subcomponent thereof or combination thereof. The same component or different components can perform parts of the method 400. The distributed nature of the components allows the system to dynamically optimize performance and responsiveness, enabling parallel handling of reasoning, tool invocation, and output summarization.

In block 402, the method 400 can cause the system to be configured to receive an input and map the input to input tokens. The input may be a single input of text, text in an image, or a combination of multiple inputs like text providing a prompt in connection with an attachment, which can be text, an image, a video, audio, or a combination of modalities.

In block 404, the method 400 can cause the system to be configured to process the input tokens using an AI model such as CoT reasoning model 127 to generate reasoning tokens and one or more tool calls. In some aspects, the reasoning tokens are generated by processing multimodal inputs via distinct AI subsystems, including at least one of: (a) a generative language model, (b) an image-processing module, or (c) a code-execution engine. This modular approach ensures that each type of input—text, image, or code—can be processed using specialized capabilities, resulting in more accurate reasoning paths and richer outputs.

In some aspects, personalization state 120 can provide stored facts or past session data to guide the CoT reasoning model 127 when generating reasoning tokens and tool calls, improving continuity and accuracy. Further, personalization state 120 can guide retrieval strategies or influence context selection when using RAG, enabling more user-specific and context-aware outputs.

In block 406, the method 400 can cause the system to be configured to perform the one or more tool calls and receive tool-call responses therefrom. The tool-call responses can include any type of response from tool 134, which can include search results, code execution outputs, and/or image manipulations, as well as other results depending on the purpose of tool 134. Integrating these tool responses enables the system to augment its internal reasoning with external computations, providing more complete and contextually relevant results.

In block 408, the method 400 can cause the system to be configured to queue the tool-call responses. An ordered message queue 125 can manage or store the queued tool-call responses to ensure correct sequencing and consistent presentation of results, even when tool executions complete asynchronously.

In block 410, the method 400 can cause the system to be configured to buffer the reasoning tokens. The operation of buffering of reasoning tokens can occur until a delta threshold is satisfied. The delta threshold may be based on a number of factors such as at least one of: (i) a difference in token count between consecutive messages; or (ii) an elapsed time threshold between message releases. This buffering smooths the delivery of reasoning outputs and avoids fragmented or disjointed updates in the user interface 103.

In block 412, the method 400 can cause the system to be configured to determine when to release the reasoning tokens and the tool-call responses to a summarization model such as summarization model 119 to provide released tool-call responses and a subset of released reasoning tokens. In some aspects, the summarization model performs asynchronous summarization of reasoning tokens while synchronous tool-call responses are released without delay. This allows the system to provide partial results in near real-time without sacrificing completeness.

In some aspects, the summarization model generates structured step summaries (such as structured thoughts 324) that can include a title indicative of a reasoning step and a description formatted for client-side parsing. The summarization model may also normalize multimodal reasoning outputs by generating standardized metadata for tool-call responses, reasoning tokens, image manipulations, or search results to enable consistent rendering of reasoning steps at the user device 102. In some aspects, the standardized metadata can include visibility flags specifying whether corresponding reasoning tokens or tool-call responses are displayable or designated as protected intermediate reasoning. The analysis channel 318 can use the visibility flags to determine protection actions.

In some aspects, the summarization model can incorporate previously generated step summaries when producing a subsequent step summary to maintain contextual continuity across multiple reasoning steps. Such continuity enables the user to follow the sequence of reasoning steps and understand how earlier analyses relate to later conclusions. The summarization model can dynamically adapt the style, tone, or verbosity of step summaries based on client-specific rendering policies or user preferences.

With respect to tool-call responses mentioned above, the summarization model can format the tool-call responses as structured outputs for display on the user interface 103. Structured outputs make multimodal responses easier for the user to interpret and support consistent downstream processing.

In block 414, the method 400 can cause the system to be configured to generate, via the summarization model and based on the released tool call responses of the subset of released reasoning tokens, a step summary of a multi-step reasoning process. The step summary may include a reasoning recap message representing an executive summary of reasoning outputs for an entire conversational turn. The step summary can be output as a structured message (i.e., structured thoughts 324) which can include multiple message types, including one or more of structured thoughts, search citations, tool-call results, or multimodal visualizations.

In block 416, the method 400 can cause the system to be configured to return the step summary (to an API or to display in a conversation-thread portion of a user interface 103.

In some aspects, the method 400 can further cause the system to be configured to maintain, via a backend processing system such as backend orchestration and summarization engine 316, an ordered message queue 125 to preserve a display order of step summaries and tool-call responses. The system can be configured to release processed outputs only when their corresponding summarization tasks are completed.

In some aspects, the method 400 can further cause the system to be configured to assign, via a backend processing system, reasoning tokens and tool-call responses to logical channels, including an analysis channel 318 for intermediate reasoning and at least one display channel for sanitized summaries and structured multimodal data.

In some aspects, a system is disclosed for multimodal chain-of-thought reasoning or artificial intelligence (AI) reasoning. The system can include one or more processor; and a computer-readable storage device storing instructions which, when executed by the one or more processor, cause the one or more processor to be configured to: receive an input and map the input to a set of input tokens; process the set of input tokens using an AI model to generate reasoning tokens and one or more tool calls; perform the one or more tool calls and receive tool-call responses therefrom; queue the tool-call responses; buffer the reasoning tokens; determine when to release the reasoning tokens and the tool-call responses to a summarization model to provide released tool-call responses and a subset of released reasoning tokens; generate, by the summarization model and based on the released tool-call responses and the subset of released reasoning tokens, a step summary of a multi-step reasoning process; and return the step summary to an application programming interface or for display in a conversation-thread portion of a user interface.

In some aspects, a computer-readable storage device or medium is disclosed for storing instructions which, when executed by one or more processor, cause the one or more processor to be configured to: receive an input and map the input to a set of input tokens; process the set of input tokens using a chain-of-thought (CoT) reasoning model to generate reasoning tokens and one or more tool calls; perform the one or more tool calls and receive tool-call responses therefrom; queue the tool-call responses; buffer the reasoning tokens; determine when to release the reasoning tokens and the tool-call responses to a summarization model to provide released tool-call responses and a subset of released reasoning tokens; generate, by the summarization model and based on the released tool-call responses and the subset of released reasoning tokens, a step summary of a multi-step reasoning process; and return the step summary to an application programming interface or for display in a conversation-thread portion of a user interface. The input can be, for example, at least one image and text or other modalities of input.

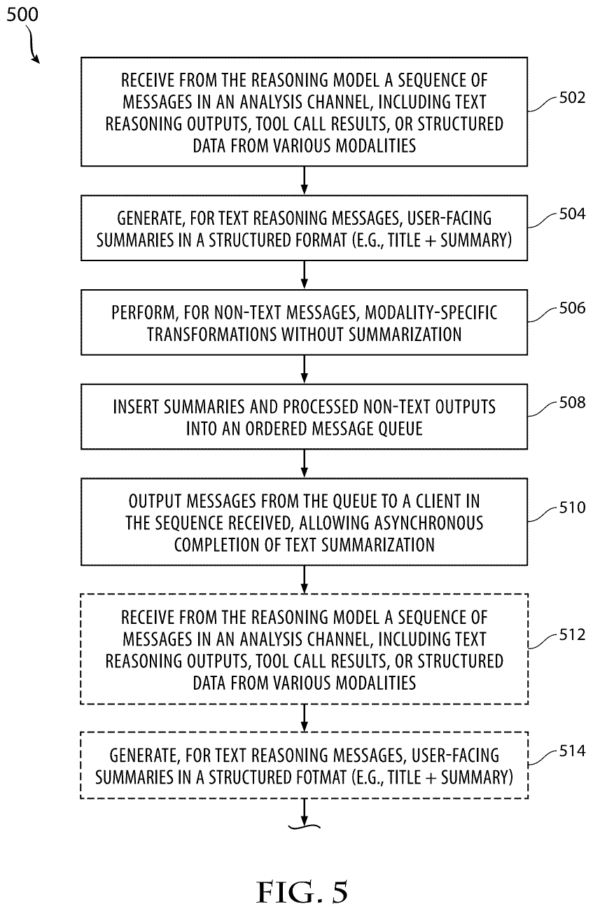

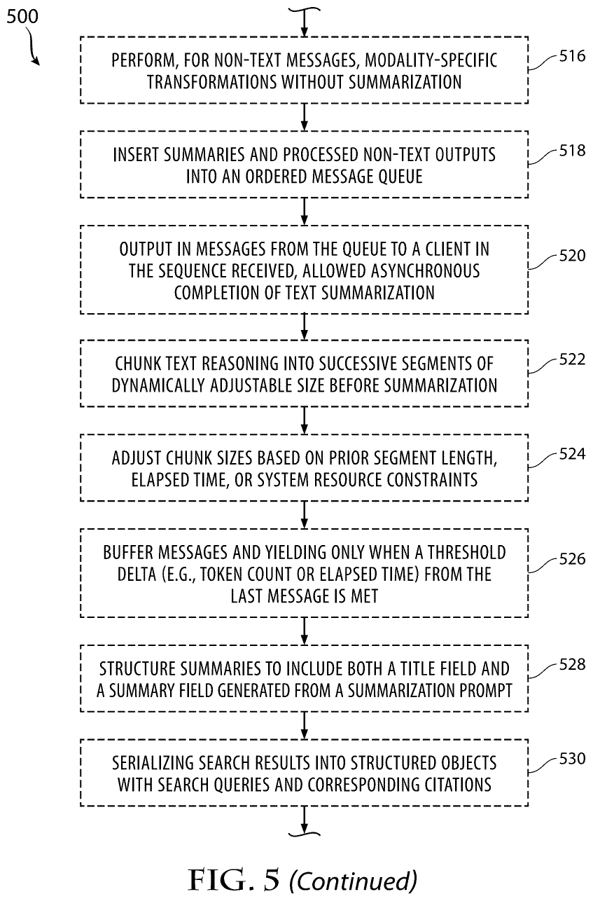

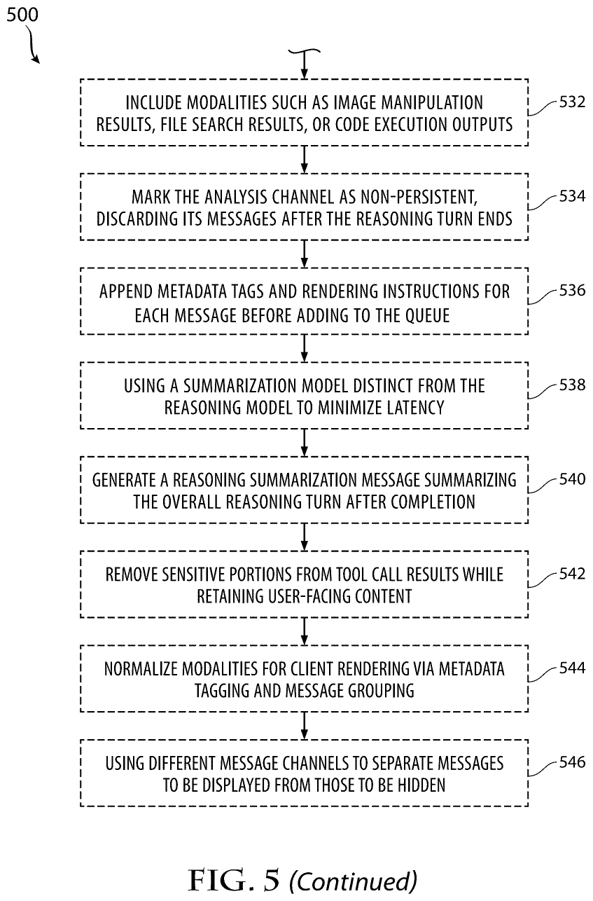

FIG. 5 illustrates an example of a backend orchestration and summarization method, such as method 500, that a system can perform. The system can consist of one or more user devices such as user device 102, a tool 134, a generative response engine 112, AI model(s) 126, summarization model 119, CoT reasoning model 127, ordered message queue 125, backend orchestration and summarization engine 316, a computing system 700, a processor 704 and/or any subcomponent thereof or combination thereof. The same component or different components can perform parts of the method 500. The method 500 may include any one or more of the following described operations performed by the system in any order.

Although method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions substantially simultaneously or in a specific sequence. The method 500 can include any one or more of the steps disclosed below.

In block 502, the method 500 can cause the system to receive from the reasoning model a sequence of messages in an analysis channel 318, including text reasoning outputs, tool call results, or structured data from various modalities. The approach enables the system to collect intermediate reasoning steps and outputs from tool calls into a single channel for coordinated handling.

When retrieval-augmented generation (RAG) is invoked, external content retrieved via a file connector (e.g., Google Drive, Slack, or Confluence) can be streamed into the reasoning process and treated as additional input tokens before summarization. These retrieved results are integrated alongside reasoning tokens, tool-call responses, and personalization state 120, ensuring that summaries and multimodal outputs reflect both retrieved knowledge and user-specific context.

In block 504, the method 500 can cause the system to generate, for text reasoning messages, user-facing summaries in a structured format (e.g., a title and summary). Structured summaries enable the user interface 103 to surface concise, high-level insights while maintaining traceability to detailed intermediate reasoning when needed.

In block 506, the method 500 can cause the system to perform, for non-text messages or non-text input such as attachment 106, modality-specific transformations without summarization. Examples include normalizing image outputs, formatting code execution results, and structuring search results for display, ensuring consistent and predictable handling of multimodal outputs.

Additionally, when a retrieval-augmented generation process is triggered, retrieved content from external sources is formatted and normalized as structured tokens before being queued in ordered message queue 125. These tokens can be integrated seamlessly with reasoning outputs for consistent summarization and display.

In block 508, the method 500 can cause the system to insert summaries and processed non-text outputs into an ordered message queue 125. The ordered message queue 125 ensures that asynchronous tool outputs and summarization results are preserved and displayed in their proper logical sequence.

In block 510, the method 500 can cause the system to buffer messages and yield them only when a threshold delta is met. The delta threshold can be based on token count, elapsed time, or resource limits, reducing fragmentation and preserving conversational continuity.

The remaining blocks in FIG. 5 represent optional enhancements to the core process and may or may not be implemented in a broadest version of the method 500. The dashed-line boxes represent optional extensions.

In block 512, the method 500 can cause the system to dynamically chunk text reasoning outputs into segments of adjustable size before summarization. Chunk sizes may be adjusted dynamically based on segment length, elapsed time, or system resources, optimizing real-time summarization efficiency.

In block 514, the method 500 can cause the system to structure summaries to include both a title field and a summary field generated from a summarization prompt. This ensures summaries are concise, context-rich, and consistently formatted for client-side rendering. Other data may be provided as well, besides a title field and summary field.

In block 516, the method 500 can cause the system to serialize search results into structured objects, associating each search query with corresponding citations. This supports traceability, enabling users to verify sources and inspect detailed search outcomes.

In block 518, the method 500 can cause the system to remove sensitive portions from tool call results while retaining user-facing content. For example, authentication data, debugging variables, and other sensitive artifacts can be stripped to ensure privacy, security, and regulatory compliance. Analysis channel 318 may remove the sensitive portions of the tool call results.

In block 520, the method 500 can cause the system to normalize modalities for client rendering via metadata tagging and message grouping. Metadata allows the user interface 103 to display multimodal results consistently and in alignment with user preferences.

In block 522, the method 500 can cause the system to mark the analysis channel 318 as non-persistent, discarding its messages after the reasoning turn ends. The approach helps manage storage resources and enhances security by preventing unnecessary retention of sensitive intermediate reasoning outputs. In some aspects, the analysis channel 318 may be configured to be persistent to maintain data or certain types of data based on one or more factors.

In block 524, the method 500 can cause the system to append metadata tags and rendering instructions for each message before adding them to the queue. These tags allow downstream systems to determine visibility, rendering format, and modality grouping, enabling robust client-side display.

In block 526, the method 500 can cause the system to use a summarization model distinct from the reasoning model to minimize latency. By decoupling summarization from reasoning, the system can parallelize tasks and provide partial results more quickly to the user interface 103.

In block 528, the method 500 can cause the system to generate a reasoning summarization message summarizing the overall reasoning turn after completion. This recap provides a concise executive summary for the user while retaining links to more detailed reasoning.

In block 530, the method 500 can cause the system to include modalities such as image manipulation results, file search results, or code execution outputs within structured summaries. This allows multimodal reasoning processes to be presented cohesively within the user interface 103.

In block 532, the method 500 can cause the system to use different message channels to separate messages to be displayed from those to be hidden. This separation improves privacy by preventing the display of intermediate reasoning steps while still leveraging them internally.

In block 534, the method 500 can cause the system to generate a reasoning summarization message summarizing the overall reasoning turn after completion, providing the user with a top-level understanding of results.

In block 536, the method 500 can cause the system to append metadata tags and rendering instructions for each message before adding them to the queue. These metadata tags help ensure proper grouping, labeling, and visibility controls for multimodal messages.

In block 538, the method 500 can cause the system to generate a reasoning summarization message summarizing the overall reasoning turn after completion. This ensures users always receive a coherent, high-level explanation of the outputs regardless of the number or complexity of intermediate steps.

In block 540, the method 500 can cause the system to remove sensitive portions from tool call results while retaining user-facing content. For example, confidential parameters, API tokens, or intermediate values may be stripped to safeguard privacy while maintaining meaningful output.

In block 542, the method 500 can cause the system to normalize modalities for client rendering via metadata tagging and message grouping. This consistent normalization process enables predictable rendering of multimodal results across client applications.

In block 544, the method 500 can cause the system to include modalities such as image manipulation results, file search results, or code execution outputs within structured summaries. By integrating these outputs directly into structured summaries, the user interface 103 can present reasoning results cohesively.

In block 546, the method 500 can cause the system to use different message channels to separate messages to be displayed from those to be hidden. This controlled separation ensures that sensitive intermediate reasoning remains protected while presenting only sanitized, user-facing results.

In some aspects, a system with one or more processor and a computer-readable storage device storing instructions which, when executed by one or more processor, cause the processor to perform any one or more of the operations described above for method 500.

In some aspects, a computer-readable storage device is disclosed for storing instructions which, when executed by one or more processor, cause the one or more processor to perform the operations described above for method 500.

For clarity of explanation, in some instances, the present technology may include individual functional blocks, including devices, device components, steps, or routines in a method embodied in software, or combinations of hardware and software.

Any of the steps, operations, functions, or processes described herein may be performed or implemented by a combination of hardware and software services or services, alone or in combination with other devices. In some aspects, a service can be software that resides in the memory of a client device and/or one or more servers of a content management system and performs one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, media, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special-purpose computer, or special-purpose processing device to perform a specific function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take various form factors. Typical examples of such form factors include servers, laptops, smartphones, small form factor personal computers, personal digital assistants, and so on. The functionality described herein can also be embodied in peripherals or add-in cards. Such functionality can also be implemented on a circuit board among different chips or different processes executing in a single device, for example.

The instructions, media for conveying such instructions, computing resources for executing them, and other structures for supporting such computing resources are means for providing the functions described in these disclosures.

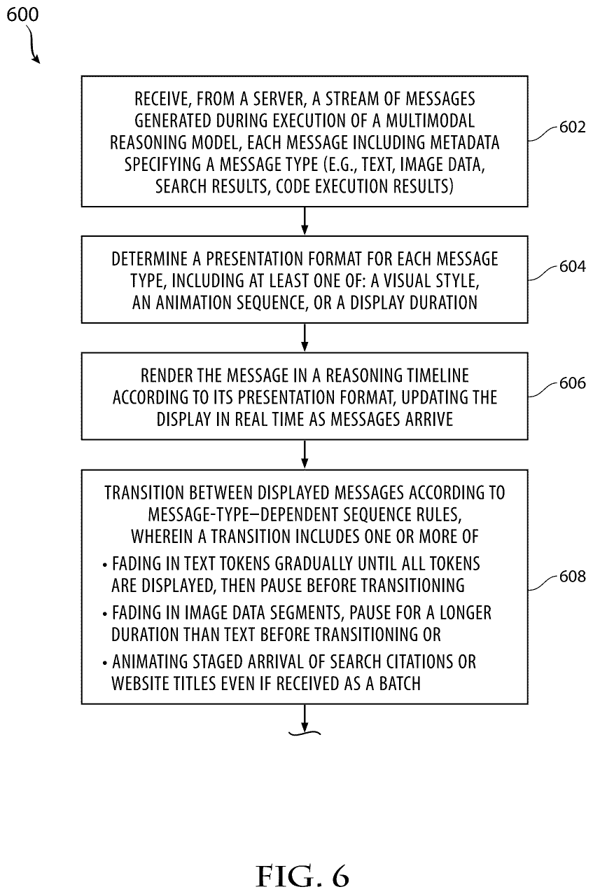

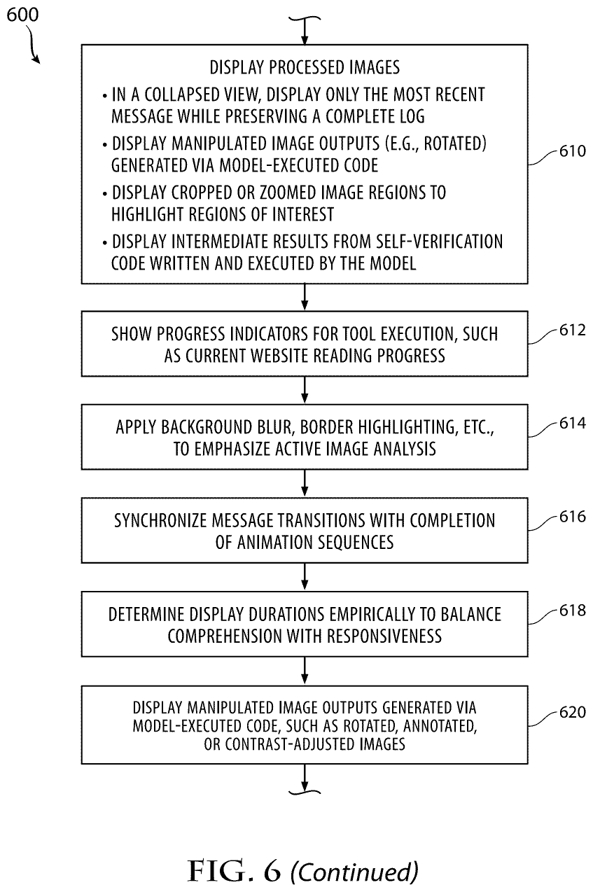

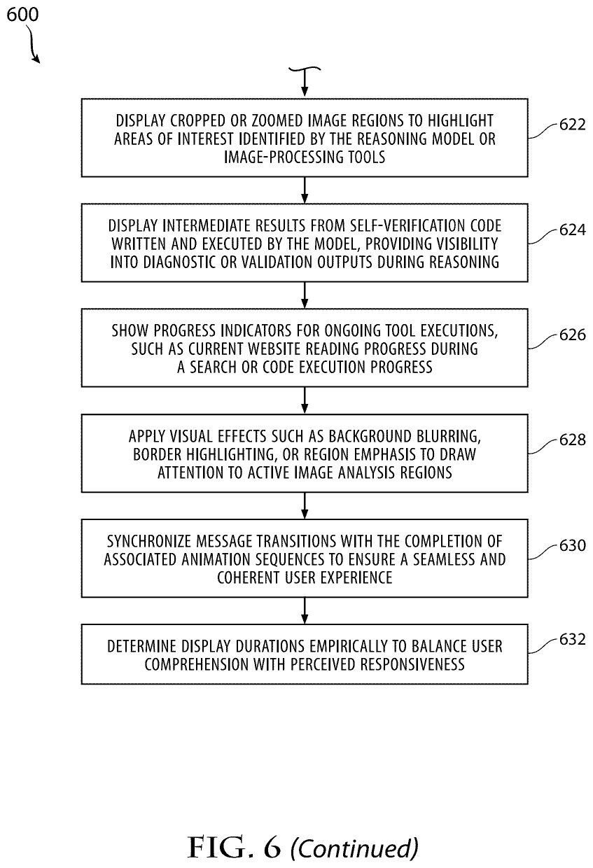

FIG. 6 illustrates an example method 600 related to presenting, in a user interface, intermediate reasoning steps of a multimodal reasoning model, according to some embodiments. This concept relates to presenting intermediate reasoning steps of a multimodal reasoning model (i.e., CoT reasoning model 127) in real time, enabling users to observe the evolution of reasoning, visual outputs, and supporting artifacts as the system processes a prompt 104. The method 600 integrates textual, visual, and external data sources into a unified, dynamic display highlighting the relationships between individual reasoning steps, intermediate outputs, and final results along a reasoning timeline 204. This concept, therefore, focuses on real-time visualization of the reasoning process to enhance interpretability and user trust. Intermediate reasoning steps, tool-call directives, and outputs are streamed as structured UI cards along a reasoning timeline. Summarization model 119 manages outputs, combining textual reasoning, processed images, annotations, and search results into cohesive snapshots.

Although the example method 600 illustrates a particular sequence of operations, the sequence may be altered without departing from the scope of the present disclosure. For example, some of the operations may be performed in parallel or in a different order, and in some implementations, different components may perform multiple functions concurrently. Method 600 can be performed by a system that consists of one or more user devices such as user device 102, a tool 134, a generative response engine 112, AI model(s) 126, summarization model 119, CoT reasoning model 127, a computing system 700, a processor 704, a system memory 708 and/or any subcomponent thereof or combination thereof. The same component or different components can perform parts of the method 600.

At block 602, the system can be configured to receive, from a server, a stream of messages generated during execution of a multimodal reasoning model or CoT reasoning model 127. Each message can include metadata specifying a message type, such as text, image data, search results, or code execution results. In some aspects, the messages are emitted in real time as the model produces reasoning steps and invokes tools, and may be delivered via a streaming protocol along with identifiers for referenced assets.

At block 604, the system can be configured to determine a presentation format for each message type. The presentation format may include at least one of a visual style, an animation sequence, or a display duration. For example, text messages can be displayed using a token-level fade-in animation, image data may be presented with extended dwell times, and search citations can be shown with staged “pill”-style animations for progressive visualization.

At block 606, the system can be configured to render each message within a reasoning timeline according to its presentation format, updating the display in real time as messages arrive. The reasoning timeline may be presented in a collapsed mode, showing only the most recent reasoning step, or in an expanded mode, showing all reasoning steps for full transparency.

In one example, while an image segmentation operation is ongoing, completed textual reasoning outputs may be displayed immediately in the reasoning timeline. Once segmentation completes, the processed image can be inserted into the same reasoning card sequence without restarting the display.

At block 608, the system can be configured to transition between displayed messages according to message-type-dependent sequencing rules. These sequencing rules can optimize pacing and ordering to balance responsiveness with readability, ensuring that users are not overwhelmed by rapid updates while still maintaining real-time visibility into the reasoning process.

At block 610, the system can be configured to display processed images generated by the multimodal reasoning model or its associated tools. Processed images can include cropped, rotated, zoomed, or contrast-enhanced variants, as well as other manipulated visual outputs optimized for display.

At block 612, the system can be configured to fade in textual tokens gradually until all tokens are displayed, and then pause briefly before transitioning to a subsequent message.

At block 614, the system can be configured to fade in image data segments and pause for a longer duration than for text messages to support visual comprehension.

At block 616, the system can be configured to animate the staged arrival of search citations or website titles, even when multiple results are received as a batch.

At block 618, the system can be configured to present a collapsed view of the reasoning timeline showing only the most recent message, while preserving a complete log of reasoning steps for later review.

At block 620, the system can be configured to display manipulated image outputs generated via model-executed code, such as rotated, annotated, or contrast-adjusted images.

At block 622, the system can be configured to display cropped or zoomed image regions to highlight areas of interest identified by the CoT reasoning model 127 or image-processing tools.

At block 624, the system can be configured to display intermediate results from self-verification code written and executed by the model, providing visibility into diagnostic or validation outputs during reasoning.

At block 626, the system can be configured to show progress indicators for ongoing tool executions, such as current website reading progress during a search or code execution progress.

At block 628, the system can be configured to apply visual effects such as background blurring, border highlighting, or region emphasis to draw attention to active image analysis regions.

At block 630, the system can be configured to synchronize message transitions with the completion of associated animation sequences to ensure a seamless and coherent user experience.

At block 632, the system can be configured to determine display durations empirically to balance user comprehension with perceived responsiveness. Display timings may be tuned based on empirical data to optimize pacing for various message types and presentation modes.

In some aspects, a computing system is disclosed for presenting intermediate reasoning steps of a multimodal reasoning model or CoT reasoning model 127. The system can include one or more processors; one or more memory devices storing instructions; and a user interface configured to render reasoning outputs, wherein the instructions, when executed by the one or more processors, cause the system to: receive, from a server, a plurality of reasoning messages generated during execution of the multimodal reasoning model or CoT reasoning model 127, each reasoning message including metadata identifying a message type; determine, based on the message type, a presentation format for each reasoning message, the presentation format including at least one of a visual style, an animation sequence, or a display duration; render, via the user interface, the plurality of reasoning messages in a reasoning timeline according to their respective presentation formats; and update the reasoning timeline in real time as additional reasoning messages are generated.

In some aspects, a non-transitory computer-readable storage medium is disclosed for storing instructions that, when executed by one or more processors, cause a system to be configured to: receive, from a server, a plurality of reasoning messages generated during execution of a multimodal reasoning model or CoT reasoning model 127, each reasoning message including metadata identifying a message type; determine, based on the message type, a presentation format for each reasoning message, the presentation format including at least one of a visual style, an animation sequence, or a display duration; render, via a user interface, the plurality of reasoning messages in a reasoning timeline according to their respective presentation formats; and update the reasoning timeline in real time as additional reasoning messages are generated.

In some aspects, a system with one or more processor and a computer-readable storage device storing instructions which, when executed by one or more processor, cause the processor to perform any one or more of the operations described above for method 600.

In some aspects, a computer-readable storage device is disclosed for storing instructions which, when executed by one or more processor, cause the one or more processor to perform the operations described above for method 600.

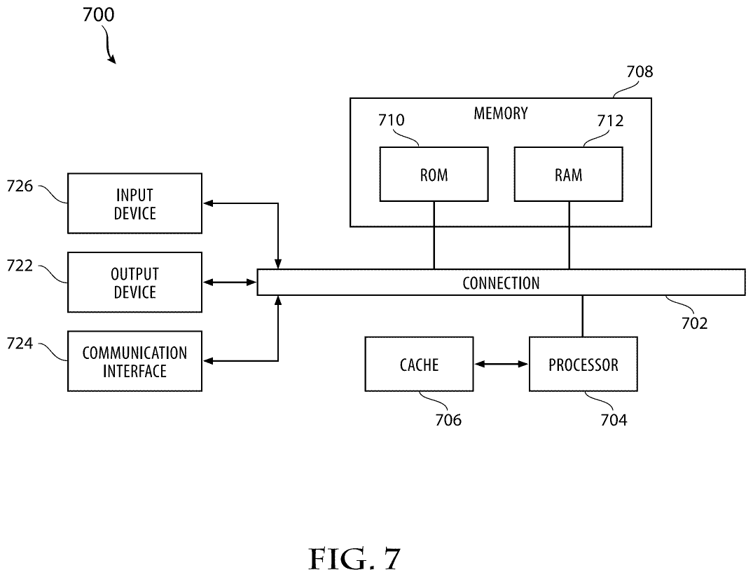

FIG. 7 shows an example of computing system 700, which can be, for example, any computing device making up any engine, model, or component illustrated in FIG. 1, FIG. 2A or FIG. 3 or any component thereof. In some aspects, computing system 700 is a single device, or a distributed system in which the functions described in this disclosure can be distributed within a datacenter, multiple data centers, a peer network, etc. In some aspects, one or more of the described system components represent many such components, each performing some or all of the function for which the component is described. In some aspects, the components can be physical or virtual devices.

In some aspects, computing system 700 may include one or more computing resources provisioned from a “cloud computing” provider, For example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 700 includes at least one central processing unit (CPU or processor) such as processor 704 and connection 702 that couples various system components, including system memory 708, such as read-only memory (ROM) or ROM 710, and random-access memory (RAM) or RAM 712 to processor 704. System memory 708 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

System memory 708 can include software services, servers, logic, etc., that when the code that defines such software is executed by the processor 704, it causes the system to perform a function. In some aspects, a hardware service that performs a particular function can include the software component stored in a computer-readable medium in connection with the necessary hardware components, such as processor 704, connection 702, output device 722, etc., to carry out the function.

Computing system 700 can include a cache of high-speed memory 706 connected directly with, in close proximity to, or integrated as part of processor 704.

Connection 702 can be a physical connection via a bus, or a direct connection into processor 704, such as in a chipset architecture. Connection 702 can also be a virtual connection, networked connection, or logical connection.

Processor 704 can include any general-purpose processor and a hardware service or software service stored in system memory 708, configured to control processor 704 as well as a special-purpose processor where software instructions are incorporated into the actual processor design. Processor 704 may essentially be a completely self-contained computing system, containing multiple cores or processors, a bus, memory controller, cache, etc. A multi-core processor may be symmetric or asymmetric. Processor 704 can be physical or virtual.

To enable user interaction, computing system 700 includes an input device 726, which can represent any number of input mechanisms, such as a microphone for speech, a touch-sensitive screen for gesture or graphical input, keyboard, mouse, motion input, speech, etc. Computing system 700 can also include output device 722, which can be one or more of a number of output mechanisms known to those of skill in the art. In some instances, multimodal systems can enable a user to provide multiple types of input/output to communicate with computing system 700. Computing system 700 can include communication interface 724, which can generally govern and manage the user input and system output. There is no restriction on operating on any particular hardware arrangement, and therefore the basic features here may easily be substituted for improved hardware or firmware arrangements as they are developed.

In some aspects, computing system 700 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances, the present technology may be presented as including individual functional blocks including functional blocks including devices, device components, steps or routines in a method embodied in software, or combinations of hardware and software.

Any of the steps, operations, functions, or processes described herein may be performed or implemented by a combination of hardware and software services or services, alone or in combination with other devices. In some aspects, a service can be software that resides in memory of a client device and/or one or more servers of a content management system and perform one or more functions when a processor executes the software associated with the service. In some aspects, a service is a program or a collection of programs that carry out a specific function. In some aspects, a service can be considered a server. The memory can be a non-transitory computer-readable medium.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can include, for example, instructions and data which cause or otherwise configure a general-purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can include hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

The present technology includes computer-readable storage mediums for storing instructions, and systems for executing any one of the methods embodied in the instructions addressed in the aspects of the present technology presented below:

Aspects of this disclosure are as follows:

### Aspect Set I: Multimodal Chain-Of-Thought Reasoning

Aspect 1. A method for artificial intelligence (AI) reasoning, the method comprising: receiving an input and mapping the input to a set of input tokens; processing the set of input tokens using an AI model to generate reasoning tokens and one or more tool calls; performing the one or more tool calls and receiving tool-call responses therefrom; queueing the tool-call responses; buffering the reasoning tokens; determining when to release the reasoning tokens and the tool-call responses to a summarization model to provide released tool-call responses and a subset of released reasoning tokens; generating, by the summarization model and based on the released tool-call responses and the subset of released reasoning tokens, a step summary of a multi-step reasoning process; and returning the step summary to an application programming interface or for display in a conversation-thread portion of a user interface.

Aspect 2. The method of Aspect 1, wherein the summarization model performs asynchronous summarization of reasoning tokens while synchronous tool-call responses are released without delay and wherein the input comprises text and an attachment comprising one or more of text, an image, audio, a video and a multi-modal type of attachment.

Aspect 3. The method of any of Aspects 1-2, wherein the summarization model incrementally summarizes reasoning tokens by dynamically adjusting a size of reasoning-token chunks based on at least one of: (a) a latency threshold, (b) a token-generation rate, or (c) available summarization resources.

Aspect 4. The method of any of Aspects 1-3, wherein the summarization model generates structured step summaries comprising a title indicative of a reasoning step and a description formatted for client-side parsing.

Aspect 5. The method of any of Aspects 1-4, further comprising: maintaining, via a backend processing system, an ordered message queue to preserve a display order of step summaries and tool-call responses, releasing processed outputs only when their corresponding summarization tasks are completed.

Aspect 6. The method of Aspect 5 or any of Aspects 1-4, wherein buffering of reasoning tokens occurs until a delta threshold is satisfied, the delta threshold based on at least one of: (i) a difference in token count between consecutive messages; or (ii) an elapsed time threshold between message releases.

Aspect 7. The method of any of Aspects 1-6, wherein the summarization model normalizes multimodal reasoning outputs by generating standardized metadata for tool-call responses, reasoning tokens, image manipulations, or search results to enable consistent rendering at a user device.

Aspect 8. The method of Aspect 7 or any of Aspects 1-6, wherein the standardized metadata comprises visibility flags specifying whether corresponding reasoning tokens or tool-call responses are displayable or designated as protected intermediate reasoning.

Aspect 9. The method of any of Aspects 1-8, wherein the step summary further comprises a reasoning recap message representing an executive summary of reasoning outputs for an entire conversational turn.

Aspect 10. The method of any of Aspects 1-9, wherein the summarization model incorporates previously generated step summaries when producing a subsequent step summary to maintain contextual continuity across multiple reasoning steps.

Aspect 11. The method of any of Aspects 1-10, wherein the summarization model dynamically adapts a style, tone, or verbosity of the step summary based on client-specific rendering policies or user preferences.

Aspect 12. The method of any of Aspects 1-11, wherein the reasoning tokens are generated by processing multimodal inputs via distinct AI subsystems, including at least one of: (a) a generative language model, (b) an image-processing module, or (c) a code-execution engine.

Aspect 13. The method of any of Aspects 1-12, wherein the tool-call responses include search results, code execution outputs, or image manipulations, and the summarization model formats these responses as structured outputs for display.

Aspect 14. The method of any of Aspects 1-13, wherein the step summary is output as a structured message comprising multiple message types, comprising one or more of structured thoughts, search citations, tool-call results, or multimodal visualizations.

Aspect 15. The method of any of Aspects 1-14, further comprising: assigning, via a backend processing system, reasoning tokens and tool-call responses to logical channels, comprising an analysis channel for intermediate reasoning and at least one display channel for sanitized summaries and structured multimodal data.

Aspect 16. A system for artificial intelligence (AI) reasoning, comprising: one or more processor; and a computer-readable storage device storing instructions which, when executed by the one or more processor, cause the one or more processor to be configured to: receive an input and map the input to a set of input tokens; process the set of input tokens using an AI model to generate reasoning tokens and one or more tool calls; perform the one or more tool calls and receiving tool-call responses therefrom; queue the tool-call responses; buffer the reasoning tokens; determine when to release the reasoning tokens and the tool-call responses to a summarization model to provide released tool-call responses and a subset of released reasoning tokens; generate, by the summarization model and based on the released tool-call responses and the subset of released reasoning tokens, a step summary of a multi-step reasoning process; and return the step summary to an application programming interface or for display in a conversation-thread portion of a user interface.

Aspect 17. The system of Aspect 16, wherein the summarization model performs asynchronous summarization of reasoning tokens while synchronous tool-call responses are released without delay and wherein the input comprises text and an attachment comprising one or more of text, an image, audio, a video and a multi-modal type of attachment.

Aspect 18. The system of any of Aspects 16-17, wherein the summarization model incrementally summarizes reasoning tokens by dynamically adjusting a size of reasoning-token chunks based on at least one of: (a) a latency threshold, (b) a token-generation rate, or (c) available summarization resources.

Aspect 19. The system of any of Aspects 16-18, wherein the summarization model generates structured step summaries comprising a title indicative of a reasoning step and a description formatted for client-side parsing.

Aspect 20. The system of any of Aspects 16-19, wherein the one or more processor is configured to: maintain, via a backend processing system, an ordered message queue to preserve a display order of step summaries and tool-call responses, releasing processed outputs only when their corresponding summarization tasks are completed.

Aspect 21. The system of Aspect 20 or of any of Aspects 16-19, wherein buffering of reasoning tokens occurs until a delta threshold is satisfied, the delta threshold based on at least one of: (i) a difference in token count between consecutive messages; or (ii) an elapsed time threshold between message releases.

Aspect 22. The system of any of Aspects 16-21, wherein the summarization model normalizes multimodal reasoning outputs by generating standardized metadata for tool-call responses, reasoning tokens, image manipulations, or search results to enable consistent rendering at a user device.

Aspect 23. The system of Aspect 22 or of any of Aspects 16-21, wherein the standardized metadata comprises visibility flags specifying whether corresponding reasoning tokens or tool-call responses are displayable or designated as protected intermediate reasoning.

Aspect 24. The system of any of Aspects 16-23, wherein the step summary further comprises a reasoning recap message representing an executive summary of reasoning outputs for an entire conversational turn.

Aspect 25. The system of any of Aspects 16-24, wherein the summarization model incorporates previously generated step summaries when producing a subsequent step summary to maintain contextual continuity across multiple reasoning steps.

Aspect 26. The system of any of Aspects 16-25, wherein the summarization model dynamically adapts a style, tone, or verbosity of the step summary based on client-specific rendering policies or user preferences.

Aspect 27. The system of any of Aspects 16-26, wherein the reasoning tokens are generated by processing multimodal inputs via distinct AI subsystems, including at least one of: (a) a generative language model, (b) an image-processing module, or (c) a code-execution engine.

Aspect 28. The system of any of Aspects 16-27, wherein the tool-call responses include search results, code execution outputs, or image manipulations, and the summarization model formats these responses as structured outputs for display.

Aspect 29. The system of any of Aspects 16-28, wherein the step summary is output as a structured message comprising multiple message types, comprising one or more of structured thoughts, search citations, tool-call results, or multimodal visualizations.

Aspect 30. The system of any of Aspects 16-29, wherein the one or more processor is configured to: assign, via a backend processing system, reasoning tokens and tool-call responses to logical channels, comprising an analysis channel for intermediate reasoning and at least one display channel for sanitized summaries and structured multimodal data.

Aspect 31. A non-transitory computer-readable medium storing instructions for operating an artificial intelligence (AI) model which, when executed by one or more processor, cause the one or more processor to be configured to: receive an input and map the input to a set of input tokens; process the set of input tokens using an AI model to generate reasoning tokens and one or more tool calls; perform the one or more tool calls and receive tool-call responses therefrom; queue the tool-call responses; buffer the reasoning tokens; determine when to release the reasoning tokens and the tool-call responses to a summarization model to provide released tool-call responses and a subset of released reasoning tokens; generate, by the summarization model and based on the released tool-call responses and the subset of released reasoning tokens, a step summary of a multi-step reasoning process; and return the step summary to an application programming interface or for display in a conversation-thread portion of a user interface.

Aspect 32. The non-transitory computer-readable medium of Aspect 31, wherein the summarization model performs asynchronous summarization of reasoning tokens while synchronous tool-call responses are released without delay and wherein the input comprises text and an attachment comprising one or more of text, an image, audio, a video and a multi-modal type of attachment.

Aspect 33. The non-transitory computer-readable medium of any of Aspects 31-32, wherein the summarization model incrementally summarizes reasoning tokens by dynamically adjusting a size of reasoning-token chunks based on at least one of: (a) a latency threshold, (b) a token-generation rate, or (c) available summarization resources.

Aspect 34. The non-transitory computer-readable medium of any of Aspects 31-33, wherein the summarization model generates structured step summaries comprising a title indicative of a reasoning step and a description formatted for client-side parsing.

Aspect 35. The non-transitory computer-readable medium of any of Aspects 31-34, wherein the one or more processor is configured to: maintain, via a backend processing system, an ordered message queue to preserve a display order of step summaries and tool-call responses, releasing processed outputs only when their corresponding summarization tasks are completed.

Aspect 36. The non-transitory computer-readable medium of Aspect 35 or of any of Aspects 31-34, wherein buffering of reasoning tokens occurs until a delta threshold is satisfied, the delta threshold based on at least one of: (i) a difference in token count between consecutive messages; or (ii) an elapsed time threshold between message releases.

Aspect 37. The non-transitory computer-readable medium of any of Aspects 31-36, wherein the summarization model normalizes multimodal reasoning outputs by generating standardized metadata for tool-call responses, reasoning tokens, image manipulations, or search results to enable consistent rendering at a user device.

Aspect 38. The non-transitory computer-readable medium of Aspect 37 or of any of Aspects 31-36, wherein the standardized metadata comprises visibility flags specifying whether corresponding reasoning tokens or tool-call responses are displayable or designated as protected intermediate reasoning.

Aspect 39. The non-transitory computer-readable medium of any of Aspects 31-38, wherein the step summary further comprises a reasoning recap message representing an executive summary of reasoning outputs for an entire conversational turn.

Aspect 40. The non-transitory computer-readable medium of any of Aspects 31-39, wherein the summarization model incorporates previously generated step summaries when producing a subsequent step summary to maintain contextual continuity across multiple reasoning steps.

Aspect 41. The non-transitory computer-readable medium of any of Aspects 31-40, wherein the summarization model dynamically adapts a style, tone, or verbosity of the step summary based on client-specific rendering policies or user preferences.

Aspect 42. The non-transitory computer-readable medium of any of Aspects 31-41, wherein the reasoning tokens are generated by processing multimodal inputs via distinct AI subsystems, including at least one of: (a) a generative language model, (b) an image-processing module, or (c) a code-execution engine.

Aspect 43. The non-transitory computer-readable medium of any of Aspects 31-42, wherein the tool-call responses include search results, code execution outputs, or image manipulations, and the summarization model formats these responses as structured outputs for display.

Aspect 44. The non-transitory computer-readable medium of any of Aspects 31-43, wherein the step summary is output as a structured message comprising multiple message types, comprising one or more of structured thoughts, search citations, tool-call results, or multimodal visualizations.

Aspect 45. The non-transitory computer-readable medium of any of Aspects 31-44, wherein the one or more processor is configured to: assign, via a backend processing system, reasoning tokens and tool-call responses to logical channels, comprising an analysis channel for intermediate reasoning and at least one display channel for sanitized summaries and structured multimodal data.

### Aspect Set II: Orchestrating Multimodal Chain-of-Thought Reasoning

Aspect 1. A method for orchestrating multimodal chain-of-thought or artificial intelligence (AI) reasoning, comprising: receiving, from a reasoning model, a sequence of messages in an analysis channel, the sequence of messages including text reasoning outputs, tool-call results, and structured multimodal data; performing, for non-text messages in the sequence of messages, modality-specific transformations without summarization to generate transformed non-text outputs; generating, for text reasoning messages, user-facing summaries in a structured format; inserting the user-facing summaries and the transformed non-text outputs into an ordered message queue; outputting, from the ordered message queue, the user-facing summaries and the transformed non-text outputs to a client in a received sequence; and marking the analysis channel as non-persistent and discarding its messages after a reasoning turn ends.

Aspect 2. The method of Aspect 1, wherein the structured format for the user-facing summaries comprises at least a title field and a summary field generated from a summarization prompt.

Aspect 3. The method of any of Aspects 1-2, wherein the structured format for the user-facing summaries is generated using a summarization model distinct from the reasoning model to minimize latency between receiving the sequence of messages and displaying the user-facing summaries.

Aspect 4. The method of any of Aspects 1-3, further comprising chunking text reasoning outputs into successive segments of dynamically adjustable size prior to generating the user-facing summaries, wherein a chunk size is determined based on at least one of: a length of a previously summarized segment, an elapsed time threshold, or system resource constraints.

Aspect 5. The method of any of Aspects 1-4, wherein the ordered message queue supports asynchronous completion of generating the user-facing summaries while allowing synchronous release of the tool-call results, thereby preserving the received sequence while reducing perceived latency.

Aspect 6. The method of any of Aspects 1-5, further comprising: serializing search results obtained from a tool call into structured search objects comprising search queries and corresponding citations; and inserting the structured search objects into the ordered message queue for client-side rendering.

Aspect 7. The method of any of Aspects 1-6, further comprising buffering text reasoning outputs until a delta threshold is satisfied, wherein the delta threshold is based on at least one of: a token count difference between consecutive text reasoning messages, or an elapsed time since a last buffered message.

Aspect 8. The method of any of Aspects 1-7, further comprising appending metadata tags and rendering instructions to each of the user-facing summaries and the transformed non-text outputs prior to inserting them into the ordered message queue, the metadata tags specifying visibility flags for client rendering.

Aspect 9. The method of any of Aspects 1-8, further comprising removing sensitive portions of the tool-call results prior to generating the transformed non-text outputs while retaining user-facing content.

Aspect 10. The method of any of Aspects 1-9, wherein the transformed non-text outputs comprise at least one of: image manipulation results, file search results, code execution outputs, or multimodal structured data objects.

Aspect 11. The method of any of Aspects 1-10, further comprising using separate message channels for: messages to be displayed to a client, and messages to be hidden from client view, thereby protecting sensitive intermediate reasoning while maintaining ordered multimodal integration.

Aspect 12. A system for orchestrating multimodal chain-of-thought reasoning, the system comprising: one or more processor; and a non-transitory computer-readable storage device storing instructions which, when executed by the one or more processor, cause the one or more processor to: receive, from a reasoning model, a sequence of messages in an analysis channel, the sequence of messages including text reasoning outputs, tool-call results, and structured multimodal data; perform, for non-text messages in the sequence of messages, modality-specific transformations without summarization to generate transformed non-text outputs; generate, for text reasoning messages, user-facing summaries in a structured format; insert the user-facing summaries and the transformed non-text outputs into an ordered message queue; output, from the ordered message queue, the user-facing summaries and the transformed non-text outputs to a client in a received sequence; and mark the analysis channel as non-persistent and discard its messages after a reasoning turn ends.

Aspect 13. The system of Aspect 12, wherein the structured format for the user-facing summaries comprises at least a title field and a summary field generated from a summarization prompt.

Aspect 14. The system of any of Aspects 12-13, wherein the structured format for the user-facing summaries is generated using a summarization model distinct from the reasoning model to minimize latency between receiving the sequence of messages and displaying the user-facing summaries.

Aspect 15. The system of any of Aspects 12-14, wherein the one or more processor are further configured to chunk text reasoning outputs into successive segments of dynamically adjustable size prior to generating the user-facing summaries, wherein a chunk size is determined based on at least one of: a length of a previously summarized segment, an elapsed time threshold, or system resource constraints.

Aspect 16. The system of any of Aspects 12-15, wherein the ordered message queue supports asynchronous completion of generating the user-facing summaries while allowing synchronous release of the tool-call results, thereby preserving the received sequence while reducing perceived latency.

Aspect 17. The system of any of Aspects 12-16, wherein the one or more processor are further configured to: serialize search results obtained from a tool call into structured search objects comprising search queries and corresponding citations; and insert the structured search objects into the ordered message queue for client-side rendering.

Aspect 18. The system of any of Aspects 12-17, wherein the one or more processor are further configured to buffer text reasoning outputs until a delta threshold is satisfied, wherein the delta threshold is based on at least one of: a token count difference between consecutive text reasoning messages, or an elapsed time since a last buffered message.

Aspect 19. The system of any of Aspects 12-18, wherein the one or more processor are further configured to append metadata tags and rendering instructions to each of the user-facing summaries and the transformed non-text outputs prior to inserting them into the ordered message queue, the metadata tags specifying visibility flags for client rendering.

Aspect 20. The system of any of Aspects 12-19, wherein the one or more processor are further configured to remove sensitive portions of the tool-call results prior to generating the transformed non-text outputs while retaining user-facing content.

Aspect 21. The system of any of Aspects 12-20, wherein the transformed non-text outputs comprise at least one of: image manipulation results, file search results, code execution outputs, or multimodal structured data objects.

Aspect 22. The system of any of Aspects 12-21, wherein the one or more processor are further configured to use separate message channels for: messages to be displayed to a client, and messages to be hidden from client view, thereby protecting sensitive intermediate reasoning while maintaining ordered multimodal integration.

Aspect 23. A computer-readable medium storing instructions which, when executed by one or more processor, cause the one or more processor to perform a method for orchestrating multimodal chain-of-thought reasoning, the method comprising: receiving, from a reasoning model, a sequence of messages in an analysis channel, the sequence of messages including text reasoning outputs, tool-call results, and structured multimodal data; performing, for non-text messages in the sequence of messages, modality-specific transformations without summarization to generate transformed non-text outputs; generating, for text reasoning messages, user-facing summaries in a structured format; inserting the user-facing summaries and the transformed non-text outputs into an ordered message queue; outputting, from the ordered message queue, the user-facing summaries and the transformed non-text outputs to a client in a received sequence; and marking the analysis channel as non-persistent and discarding its messages after a reasoning turn ends.

Aspect 24. The computer-readable medium of Aspect 23, wherein the structured format for the user-facing summaries comprises at least a title field and a summary field generated from a summarization prompt.

Aspect 25. The computer-readable medium of any of Aspects 23-24, wherein the structured format for the user-facing summaries is generated using a summarization model distinct from the reasoning model to minimize latency between receiving the sequence of messages and displaying the user-facing summaries.

Aspect 26. The computer-readable medium of any of Aspects 23-25, wherein the instructions further cause the one or more processor to chunk text reasoning outputs into successive segments of dynamically adjustable size prior to generating the user-facing summaries, wherein a chunk size is determined based on at least one of: a length of a previously summarized segment, an elapsed time threshold, or system resource constraints.

Aspect 27. The computer-readable medium of any of Aspects 23-26, wherein the ordered message queue supports asynchronous completion of generating the user-facing summaries while allowing synchronous release of the tool-call results, thereby preserving the received sequence while reducing perceived latency.

Aspect 28. The computer-readable medium of any of Aspects 23-27, wherein the instructions further cause the one or more processor to: serialize search results obtained from a tool call into structured search objects comprising search queries and corresponding citations; and insert the structured search objects into the ordered message queue for client-side rendering.

Aspect 29. The computer-readable medium of any of Aspects 23-28, wherein the instructions further cause the one or more processor to buffer text reasoning outputs until a delta threshold is satisfied, wherein the delta threshold is based on at least one of: a token count difference between consecutive text reasoning messages, or an elapsed time since a last buffered message.

Aspect 30. The computer-readable medium of any of Aspects 23-29, wherein the instructions further cause the one or more processor to append metadata tags and rendering instructions to each of the user-facing summaries and the transformed non-text outputs prior to inserting them into the ordered message queue, the metadata tags specifying visibility flags for client rendering.

Aspect 31. The computer-readable medium of any of Aspects 23-30, wherein the instructions further cause the one or more processor to remove sensitive portions of the tool-call results prior to generating the transformed non-text outputs while retaining user-facing content.

Aspect 32. The computer-readable medium of any of Aspects 23-31, wherein the transformed non-text outputs comprise at least one of: image manipulation results, file search results, code execution outputs, or multimodal structured data objects.

Aspect 33. The computer-readable medium of any of Aspects 23-32, wherein the instructions further cause the one or more processor to use separate message channels for: messages to be displayed to a client, and messages to be hidden from client view, thereby protecting sensitive intermediate reasoning while maintaining ordered multimodal integration.

### Aspect Set III: Receiving Multimodal Reasoning Messages, Determining Formats, Rendering a Timeline, and Updating the Timeline

Aspect 1. A method for presenting intermediate reasoning steps of a multimodal reasoning model, the method comprising: receiving, from a server, a plurality of reasoning messages generated during execution of the multimodal reasoning model, each reasoning message including metadata identifying a message type, the message type comprising at least one of: a text output, an image output, a search result, or a code execution result; determining, based on the message type, a presentation format for each reasoning message, the presentation format including at least one of a visual style, an animation sequence, or a display duration; rendering, via a user interface, the plurality of reasoning messages in a reasoning timeline according to their respective presentation formats; and updating the reasoning timeline in real time as additional reasoning messages are generated, thereby presenting intermediate outputs of the multimodal reasoning model to a user.

Aspect 2. The method of Aspect 1, wherein the reasoning timeline is presented in a collapsed mode showing only a most recent reasoning message and in an expanded mode displaying all reasoning messages for full transparency.

Aspect 3. The method of any of Aspects 1-2, wherein determining the presentation format further comprises applying message-type-dependent sequencing rules that control pacing and ordering of reasoning messages to balance responsiveness and readability.

Aspect 4. The method of any of Aspects 1-3, further comprising displaying processed images, wherein the processed images are generated by an image-processing tool invoked by the multimodal reasoning model.

Aspect 5. The method of any of Aspects 1-4, wherein the processed images comprise manipulated image outputs, the manipulated image outputs including at least one of: a cropped region, a rotated image, a contrast-adjusted image, or an annotated image.

Aspect 6. The method of any of Aspects 1-5, wherein the processed images include cropped or zoomed image regions to highlight areas of interest determined by the multimodal reasoning model or an associated tool.

Aspect 7. The method of any of Aspects 1-6, wherein rendering the plurality of reasoning messages further comprises animating a staged arrival of search results by sequentially displaying search citations, website titles, or other retrieved artifacts as they are generated.

Aspect 8. The method of any of Aspects 1-7, further comprising displaying progress indicators associated with active tool executions, the progress indicators including at least one of: website reading progress, code execution progress, or image-processing status.

Aspect 9. The method of any of Aspects 1-8, wherein rendering the plurality of reasoning messages further comprises applying visual emphasis effects including at least one of: background blurring, border highlighting, region shading, or contrast adjustments to distinguish active reasoning outputs.

Aspect 10. The method of any of Aspects 1-9, further comprising synchronizing transitions between displayed reasoning messages with completion of associated animation sequences to provide a coherent and seamless presentation.

Aspect 11. The method of any of Aspects 1-10, wherein the presentation format is determined based on empirically optimized display durations selected to balance user comprehension with perceived responsiveness.

Aspect 12. The method of any of Aspects 1-11, wherein updating the reasoning timeline comprises dynamically interleaving textual reasoning outputs with multimodal artifacts, including search citations, processed images, and code-execution results, to present a unified, real-time reasoning narrative.

Aspect 13. A system for presenting intermediate reasoning steps of a multimodal reasoning model, the system comprising: one or more processors; one or more memory devices storing instructions; and a user interface configured to render reasoning outputs, wherein the instructions, when executed by the one or more processors, cause the one or more processors to: receive, from a server, a plurality of reasoning messages generated during execution of the multimodal reasoning model, each reasoning message including metadata identifying a message type; determine, based on the message type, a presentation format for each reasoning message, the presentation format including at least one of a visual style, an animation sequence, or a display duration; render, via the user interface, the plurality of reasoning messages in a reasoning timeline according to their respective presentation formats; and update the reasoning timeline in real time as additional reasoning messages are generated.

Aspect 14. The system of Aspect 13, wherein the user interface is configured to present the reasoning timeline in a collapsed mode showing only a most recent reasoning message and in an expanded mode displaying all reasoning messages.

Aspect 15. The system of any of Aspects 13-14, wherein the system is configured to apply message-type-dependent sequencing rules that control pacing and ordering of reasoning messages to balance responsiveness and readability.

Aspect 16. The system of any of Aspects 13-15, wherein the one or more processors is further configured to display processed images generated by an image-processing tool invoked by the multimodal reasoning model.

Aspect 17. The system of any of Aspects 13-16, wherein the processed images comprise manipulated image outputs, the manipulated image outputs including at least one of: a cropped region, a rotated image, a contrast-adjusted image, or an annotated image.

Aspect 18. The system of any of Aspects 13-17, wherein the processed images include cropped or zoomed image regions to highlight areas of interest determined by the multimodal reasoning model or an associated tool.

Aspect 19. The system of any of Aspects 13-18, wherein the user interface is configured to animate a staged arrival of search results by sequentially displaying search citations or website titles as they are retrieved.

Aspect 20. The system of any of Aspects 13-19, wherein the one or more processors is further configured to display progress indicators associated with active tool executions, including website reading progress, code execution status, or image-processing completion.

Aspect 21. The system of any of Aspects 13-20, wherein the one or more processors is further configured to render the plurality of reasoning messages by applying visual emphasis effects including at least one of: background blurring, border highlighting, region shading, or contrast adjustments to distinguish active reasoning outputs.

Aspect 22. The system of any of Aspects 13-21, wherein the system is configured to synchronize transitions between displayed reasoning messages with completion of associated animation sequences.

Aspect 23. The system of any of Aspects 13-22, wherein the presentation format is determined based on empirically optimized display durations selected to balance user comprehension with perceived responsiveness.

Aspect 24. The system of any of Aspects 13-23, wherein the system dynamically interleaves textual reasoning outputs with multimodal artifacts, including search citations, processed images, and code-execution results, to present a unified reasoning narrative.

Aspect 25. A non-transitory computer-readable storage medium storing instructions that, when executed by one or more processors, cause the one or more processors to be configured to: receive, from a server, a plurality of reasoning messages generated during execution of a multimodal reasoning model, each reasoning message including metadata identifying a message type; determine, based on the message type, a presentation format for each reasoning message, the presentation format including at least one of a visual style, an animation sequence, or a display duration; render, via a user interface, the plurality of reasoning messages in a reasoning timeline according to their respective presentation formats; and update the reasoning timeline in real time as additional reasoning messages are generated.

Aspect 26. The non-transitory computer-readable storage medium of Aspect 25, wherein the reasoning timeline is presented in a collapsed mode showing only a most recent reasoning message and in an expanded mode displaying all reasoning messages.

Aspect 27. The non-transitory computer-readable storage medium of Aspect 25, wherein the instructions further cause the one or more processors to be configured to apply message-type-dependent sequencing rules to control pacing and ordering of reasoning messages.

Aspect 28. The non-transitory computer-readable storage medium of Aspect 25, wherein the instructions further cause the one or more processors to be configured to display processed images generated by an image-processing tool invoked by the multimodal reasoning model.

Aspect 29. The non-transitory computer-readable storage medium of Aspect 28, wherein the processed images comprise manipulated image outputs, the manipulated image outputs including at least one of: a cropped region, a rotated image, a contrast-adjusted image, or an annotated image.

Aspect 30. The non-transitory computer-readable storage medium of Aspect 28, wherein the processed images include cropped or zoomed image regions to highlight areas of interest determined by the multimodal reasoning model or an associated tool.

Aspect 31. The non-transitory computer-readable storage medium of Aspect 25, wherein the instructions further cause the one or more processors to be configured to animate staged arrival of search results by sequentially displaying search citations or website titles as they are retrieved.

Aspect 32. The non-transitory computer-readable storage medium of Aspect 25, wherein the instructions further cause the one or more processors to be configured to display progress indicators associated with active tool executions, including website reading progress, code execution status, or image-processing completion.

Aspect 33. The non-transitory computer-readable storage medium of Aspect 25, wherein the instructions further cause the one or more processors to be configured to render the plurality of reasoning messages by applying visual emphasis effects including at least one of: background blurring, border highlighting, region shading, or contrast adjustments.

Aspect 34. The non-transitory computer-readable storage medium of Aspect 25, wherein the instructions further cause the one or more processors to be configured to synchronize transitions between displayed reasoning messages with completion of associated animation sequences.

Aspect 35. The non-transitory computer-readable storage medium of Aspect 25, wherein the presentation format is determined based on empirically optimized display durations selected to balance user comprehension with perceived responsiveness.

Aspect 36. The non-transitory computer-readable storage medium of Aspect 25, wherein the instructions further cause the one or more processors to be configured to dynamically interleave textual reasoning outputs with multimodal artifacts, including search citations, processed images, and code-execution results, to present a unified reasoning narrative.

What is claimed is:

1. A method for presenting intermediate reasoning steps of a multimodal reasoning model, the method comprising:
receiving, from a server, a plurality of reasoning messages generated during execution of the multimodal reasoning model, each reasoning message including metadata identifying a message type, the message type comprising at least one of: a text output, an image output, a search result, or a code execution result; determining, based on the message type, a presentation format for each reasoning message, the presentation format including at least one of a visual style, an animation sequence, or a display duration;
rendering, via a user interface, the plurality of reasoning messages in a reasoning timeline according to their respective presentation formats; and
updating the reasoning timeline in real time as additional reasoning messages are generated, thereby presenting intermediate outputs of the multimodal reasoning model to a user.

2. The method of claim 1, wherein the reasoning timeline is presented in a collapsed mode showing only a most recent reasoning message and in an expanded mode displaying all reasoning messages for full transparency.

3. The method of claim 1, wherein determining the presentation format further comprises applying message-type-dependent sequencing rules that control pacing and ordering of reasoning messages to balance responsiveness and readability.

4. The method of claim 1, further comprising:
displaying processed images, wherein the processed images are generated by an image-processing tool invoked by the multimodal reasoning model.

5. The method of claim 4, wherein the processed images comprise manipulated image outputs, the manipulated image outputs including at least one of: a cropped region, a rotated image, a contrast-adjusted image, or an annotated image.

6. The method of claim 4, wherein the processed images include cropped or zoomed image regions to highlight areas of interest determined by the multimodal reasoning model or an associated tool.

7. The method of claim 1, wherein rendering the plurality of reasoning messages further comprises animating a staged arrival of search results by sequentially displaying search citations, website titles, or other retrieved artifacts as they are generated.

8. The method of claim 1, further comprising:
displaying progress indicators associated with active tool executions, the progress indicators including at least one of: website reading progress, code execution progress, or image-processing status.

9. The method of claim 1, wherein rendering the plurality of reasoning messages further comprises applying visual emphasis effects including at least one of: background blurring, border highlighting, region shading, or contrast adjustments to distinguish active reasoning outputs.

10. The method of claim 1, further comprising:
synchronizing transitions between displayed reasoning messages with completion of associated animation sequences to provide a coherent and seamless presentation.

11. The method of claim 1, wherein the presentation format is determined based on empirically optimized display durations selected to balance user comprehension with perceived responsiveness.

12. The method of claim 1, wherein updating the reasoning timeline comprises dynamically interleaving textual reasoning outputs with multimodal artifacts, including search citations, processed images, and code-execution results, to present a unified, real-time reasoning narrative.

13. A system for presenting intermediate reasoning steps of a multimodal reasoning model, the system comprising:
one or more processors;
one or more memory devices storing instructions; and
a user interface configured to render reasoning outputs, wherein the instructions, when executed by the one or more processors, cause the one or more processors to be configured to:
receive, from a server, a plurality of reasoning messages generated during execution of the multimodal reasoning model, each reasoning message including metadata identifying a message type;
determine, based on the message type, a presentation format for each reasoning message, the presentation format including at least one of a visual style, an animation sequence, or a display duration;
render, via the user interface, the plurality of reasoning messages in a reasoning timeline according to their respective presentation formats; and
update the reasoning timeline in real time as additional reasoning messages are generated.

14. The system of claim 13, wherein the user interface is configured to present the reasoning timeline in a collapsed mode showing only a most recent reasoning message and in an expanded mode displaying all reasoning messages.

15. The system of claim 13, wherein the system is configured to apply message-type-dependent sequencing rules that control pacing and ordering of reasoning messages to balance responsiveness and readability.

16. The system of claim 13, wherein the one or more processors is further configured to display processed images generated by an image-processing tool invoked by the multimodal reasoning model.

17. The system of claim 16, wherein the processed images comprise manipulated image outputs, the manipulated image outputs including at least one of: a cropped region, a rotated image, a contrast-adjusted image, or an annotated image.

18. The system of claim 16, wherein the processed images include cropped or zoomed image regions to highlight areas of interest determined by the multimodal reasoning model or an associated tool.

19. The system of claim 13, wherein the user interface is configured to animate a staged arrival of search results by sequentially displaying search citations or website titles as they are retrieved.

20. A non-transitory computer-readable storage medium storing instructions for presenting intermediate reasoning steps of a multimodal reasoning model, the instructions, when executed by one or more processors, cause the one or more processors to be configured to:
receive, from a server, a plurality of reasoning messages generated during execution of a multimodal reasoning model, each reasoning message including metadata identifying a message type;
determine, based on the message type, a presentation format for each reasoning message, the presentation format including at least one of a visual style, an animation sequence, or a display duration; render, via a user interface, the plurality of reasoning messages in a reasoning timeline according to their respective presentation formats; and
update the reasoning timeline in real time as additional reasoning messages are generated.
